(19) United States
(12) Patent Application Publication
(10) Pub. No.: US 2017/0017018 A1
(43) Pub. Date: Jan. 19, 2017

(54) Mold Apparatus of Lens Array and Method for Using the Same

(71) Applicants: Choung-Lii Chao, New Taipei City (TW); Kung-Jeng Ma, Taipei City (TW); Wen-Chen Chou, New Taipei City (TW)

(72) Inventors: Choung-Lii Chao, New Taipei City (TW); Kung-Jeng Ma, Taipei City (TW); Wen-Chen Chou, New Taipei City (TW)

(21) Appl. No.: 15/208,701

(22) Filed: Jul. 13, 2016

(30) Foreign Application Priority Data
Jul. 15, 2015 (CN) 201510415134.4

(51) Int. Cl. G02B 3/00; C03B 23/00

(52) U.S. Cl. CPC G02B 3/0018; C03B 23/0013; G02B 3/0056; C03B 2215/46; C03B 2215/61; C03B 2215/79

(57) ABSTRACT

A mold apparatus of a lens array and a method for using the same are provided. The mold apparatus includes an upper pressing die, a lower pressing die and a plate structure. The upper pressing die includes a plurality of upper engaging portions. The lower pressing die includes a plurality of lower engaging portions. The plate structure includes a plurality of through holes. A glass article is installed at the through hole. The glass article includes a first sectional width W1. The through hole includes an upper opening and a lower opening. The upper opening corresponds to the upper pressing die. The lower opening corresponds to the lower pressing die. The upper opening includes a second sectional width W2. The lower opening includes a third sectional width W3. Wherein W1≧W2 or W1≧W3; the glass articles are extruded by the mold apparatus to manufacture the lens array.

### FIELD OF THE INVENTION

The invention relates to a mold apparatus of a lens array and method for using the same, and more particularly relates to a mold apparatus for glass-material lens array and method for using the same.

### BACKGROUND OF THE INVENTION

A portable consumer electronics product (e.g., cell phone, camera) usually includes a miniature camera module. The camera module commonly normally includes an image sensor of charge coupled device (CCD) or an image sensor of complementary metal oxide semiconductor (CMOS). The image sensor is configured to capture static images or motion images. Usually, a lens or a lens array is disposed before a light receiving surface of the image sensor in order to receive and adjust an incident light ray.

Traditionally, the surface of the lens is a curved profile. When the incident light ray in the air enters the lens, the surface of the lens could change a travel route of the incident light ray and focus the incident light ray. Furthermore, in order to expand utilization of the incident light, a plurality of lens would be arrayed to form a lens array.

In order to focus the incident light ray stably and control it easily, the lens array in the field of high-end camera or video device is manufactured through the glass materials. Moreover, more and more popular light-emitting diode (LED) also needs using the lens array to control a travel route of a light ray.

A traditional method of manufacturing the lens array comprises the following steps: First, injecting a melting glass into a mold; next, opening the mold after waiting for the melting glass to cool down and form a molded glass; next, taking the molded glass out. The molded glass includes a plurality of lens so as to form a lens array. However, the melting glass and the surface of the mold might stick each other, therefore the lens array formed normally includes cracks, scratches, irregular pressing contours around the outer surface, and thus cause a phenomenon of stress concentration. The cracks, the scratches and irregular pressing contours prevent the incident light from focusing accurately; besides the stress concentration causes the index of refraction of the glass materials is irregular. Therefore, the cracks, the scratches, irregular pressing contours and the phenomenon of the stress concentration reduce the production yields of the lens array.

Another common method is that utilizing a mold to press an entire glass plate, so as to form a lens array. However, the pressing pressure of the mold need to reach as high as tens kPa or even hundreds kPa. Therefore, it is difficult to have such ultimate molding device. In addition, the powerful pressing force may also reduce the production yields of the lens array. As a result, the manufacturing process of the lens array of the traditional glass materials still has a difficult to be conquered; therefore the overall production yield or production capacity of the glass lens array is still not significantly improved.

Therefore, how to improve the production yield or production capacity of the glass-material lens array is worth considering to a person having ordinary skills in the art.

### SUMMARY OF THE INVENTION

The main objective of the present invention is to improve the production yield or production capacity of the glass lens array.

Another objective of the present invention is to control the curvature of the surface profile of the glass lens array and homogenize the internal refractive index of the glass lens array.

A mold apparatus of a lens array is provided. The mold apparatus of the lens array includes an upper pressing die, a lower pressing die and a plate structure. The upper pressing die includes a plurality of upper engaging portions. The lower pressing die includes a plurality of lower engaging portions. The plate structure is movably disposed between the upper pressing die and the lower pressing die. The plate structure includes a plurality of through holes disposed thereon. A glass article is installed at each of the through holes. The glass article includes a first sectional width W1. The through hole includes an upper opening and a lower opening. The upper opening corresponds to the upper pressing die. The lower opening corresponds to the lower pressing die. The upper opening includes a second sectional width W2. The lower opening includes a third sectional width W3. The upper engaging portions are disposed adjacent to the upper opening and contacted to the glass article and the lower engaging portions are disposed adjacent to the lower opening and contacted to the glass article when the upper pressing die and the lower pressing die approaches to each other.

In the aforementioned mold apparatus of the lens array, wherein W1≧W2 or W1≧W3.

In the aforementioned mold apparatus of the lens array, wherein the upper engaging portion includes a lateral width T1 and the lower engaging portion includes a lateral width T2, and W2≧T1 or W3≧T2.

In the preferred embodiment of the present invention, the plate structure includes a thickness D1, and (W2−T1)/2 is greater than the thickness D1. (W3−T2)/2 is greater than the thickness D1.

In the aforementioned mold apparatus of the lens array, the upper engaging portion includes a lateral width T1 and the lower engaging portion includes a lateral width T2, and W2≦T1 or W3≦T2.

In the aforementioned mold apparatus of the lens array, wherein the shape of at least one upper engaging portion is different from the shape of the lower engaging portion or the area of at least one upper engaging portion is different from the area of the lower engaging portion. Either the upper engaging portion or the lower engaging portion is a projecting structure, a concave structure, or a Fresnel lens structure.

In the aforementioned mold apparatus of the lens array, wherein the shape of the upper opening of the through hole is different from the shape of the lower opening of the through hole, or the area of the upper opening of the through hole is different from the area of the lower opening of the through hole. The shape of the upper opening or the lower opening is circular, oval-shaped, polygon-shaped or irregular-shaped. In the further embodiment of the present invention, the through hole includes a bore wall. The bore wall is connected to the upper opening and the lower opening. The upper opening is greater than, equal to or less than the lower opening. A sectional view of the bore wall presents as a straight line or a curve.

In the aforementioned mold apparatus of the lens array, the plate structure includes at least one first through hole and at least one second through hole. The volume of the first through hole is different from the volume of the second through hole or the shape of the first through hole is different from the shape of the second through hole. The first through holes and the second through holes are arranged sequentially or arranged alternately or arranged regularly.

In the aforementioned mold apparatus of the lens array, each of the glass articles includes a different volume, a different shape or a different index of refraction. The glass articles include at least one first configuration and at least one second configuration. The volume of the first configuration is different from the volume of the second configuration or the shape of the first configuration is different from the shape of the second configuration. The glass articles of the first configuration and the glass articles of the second configuration are arranged sequentially or arranged alternately or arranged regularly.

In the aforementioned mold apparatus of the lens array, each of the glass articles includes a different volume, a different shape or a different index of refraction. In the further embodiment of the present invention, the glass articles include at least one first index of refraction and at least one second index of refraction. The first index of refraction is different from the second index of refraction. The glass articles of the first index of refraction and the glass articles of the second index of refraction are arranged sequentially or arranged alternately or arranged regularly. The glass articles(8) include at least one first glass transition temperature and at least one second glass transition temperature. The first glass transition temperature is different from the second glass transition temperature. The glass articles(8) of the first glass transition temperature and the glass articles(8) of the second glass transition temperature are arranged sequentially or arranged alternately or arranged regularly.

In the aforementioned mold apparatus of the lens array, the plate structure is curved.

In the aforementioned mold apparatus of the lens array, the plate structure is non-transparent.

In the aforementioned mold apparatus of the lens array, the glass article is spherical, elliptical, columnar or taper.

In the aforementioned mold apparatus of the lens array, at least part of the volume of the glass article is disposed in the through hole.

In the aforementioned mold apparatus of the lens array, the volume of the glass article is greater than or equal to the volume occupied of the through hole.

In the aforementioned mold apparatus of the lens array, the upper engaging portion covers at least part of the upper opening or the lower engaging portion covers at least part of the lower opening when the upper pressing die and the lower pressing die approaches to each other.

In the aforementioned mold apparatus of the lens array, the plate structure includes at least one spillway disposed adjacent to the through hole. The spillway is connected to the through hole.

A method for using a mold apparatus of a lens array is also provided. The mold apparatus of the lens array includes an upper pressing die, a lower pressing die and a plate structure. The plate structure includes a plurality of through holes disposed thereon. The method for using a mold apparatus of a lens array comprises the following steps: step S01: providing the mold apparatus of the lens array and a plurality of glass articles; step S02: installing at least part of the volume of the glass articles into the through holes; step S03: approaching the upper pressing die and the lower pressing die; step S06: the upper pressing die and the lower pressing die extruding the glass articles to have the glass articles deformed; step S07: the glass articles closely engaged to the through holes of the plate structure; and step S08: taking out the plate structure to form a lens array.

In the aforementioned method for using a mold apparatus of a lens array, the glass articles of the step S02 are clamped into the through holes by a robot arm or the glass articles of the step S02 roll to enter the through holes.

In the aforementioned method for using a mold apparatus of a lens array, further comprising a step Tb is implemented at least once before the step S02 or after the step S02. The step Tb heats up a plurality of glass articles.

In the aforementioned method for using a mold apparatus of a lens array, the step Ta makes the surface of the plate structure or the interior of the plate structure be non-transparent. In the further embodiment of the present invention, the plate structure is non-transparent through surface coating method, surface blasting method, atomizing surface method, or internal doping method.

In the aforementioned method for using a mold apparatus of a lens array, the glass article includes a first sectional width W1. The upper opening of the through hole includes a second sectional width W2. The lower opening of the through hole includes a third sectional width W3, and W1≧W2 or W1≧W3.

In the aforementioned method for using a mold apparatus of a lens array, the step S03 further comprises a sub-step S04 or a sub-step S05. The sub-step S04: the upper pressing die approaching the plate structure and contacting to the glass articles and the sub-step S05: the lower pressing die approaching the plate structure and contacting to the glass articles.

In the aforementioned method for using a mold apparatus of a lens array, the glass articles are extruded to form an upper end portion and a lower end portion after the step S06. The upper end portion and the lower end portion are disposed at two ends of the through hole. The lateral width of the upper end portion is greater than or equal to the sectional width of the through hole, or the lateral width of the lower end portion is greater than or equal to the sectional width of the through hole.

Therefore, the mold apparatus of the lens array and method for using the same of the present invention could control the curvature of the surface profile of the glass lens array. As a result, the present invention makes the surface profile of each of the lens arrays finished form a perfect curve and homogenizes the internal refractive index of the lens array, so that the production yield or production capacity of the glass lens array is hence improved.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A illustrates a schematic diagram of a mold apparatus of a lens array before approaching the upper pressing die and the lower pressing die according to the present invention;

FIG. 1B illustrates a schematic diagram of the mold apparatus of the lens array after approaching the upper pressing die and the lower pressing die according to the present invention;

FIG. 2 illustrates a flow chart of a method for using the mold apparatus of the lens array according to the present invention;

FIG. 3A˜3E illustrates a flow chart of the method for using the mold apparatus of the lens array in accordance with another embodiment of the present invention;

FIG. 4 illustrates a schematic diagram of a glass article corresponding to a plate structure;

FIG. 5 illustrates a schematic diagram of the lens array finished;

FIG. 6˜9 illustrates a schematic diagram of the mold apparatus of the lens array after approaching the upper pressing die and the lower pressing die in accordance with another embodiment of the present invention;

FIG. 10˜13 illustrates a schematic diagram of the glass article corresponding to the plate structure in accordance with another embodiment of the present invention.

FIG. 14 illustrates a schematic diagram of different types of the glass articles.

FIG. 15A˜16B illustrates a schematic diagram of the mold apparatus of the lens array after approaching the upper pressing die and the lower pressing die in accordance with another embodiment of the present invention;

FIG. 17˜25 illustrates a schematic diagram of combining the glass article with the plate structure in accordance with another embodiment;

FIG. 23˜31 illustrates a schematic diagram of different types of the plate structures;

FIG. 32 illustrates a schematic diagram of the structure of the mold apparatus in accordance with another embodiment;

FIG. 33˜36 illustrates a schematic diagram of the plate structure presenting as a curve;

FIG. 37˜38 illustrates a schematic diagram of different types of the lens arrays;

FIG. 39˜41 illustrates a schematic diagram of the non-transparent plate structure;

FIG. 42A˜42B illustrates a flow chart of the method for using the mold apparatus of the lens array in accordance with another embodiment of the present invention;

FIG. 43A illustrates a schematic diagram of the mold apparatus of the lens array before approaching the upper pressing die and the lower pressing die in accordance with another embodiment of the present invention;

FIG. 43B illustrates a schematic diagram of the mold apparatus of the lens array after approaching the upper pressing die and the lower pressing die in accordance with another embodiment of the present invention;

FIG. 43C illustrates a schematic diagram of the lens array finished in accordance with another embodiment of the present invention;

FIG. 44A illustrates a schematic diagram of the mold apparatus of the lens array before approaching the upper pressing die and the lower pressing die in accordance with another embodiment of the present invention;

FIG. 44B illustrates a schematic diagram of the mold apparatus of the lens array after approaching the upper pressing die and the lower pressing die in accordance with another embodiment of the present invention;

FIG. 45A illustrates a schematic diagram of the mold apparatus of the lens array before approaching the upper pressing die and the lower pressing die in accordance with another embodiment of the present invention;

FIG. 45B illustrates a schematic diagram of the mold apparatus of the lens array after approaching the upper pressing die and the lower pressing die in accordance with another embodiment of the present invention;

FIG. 46A˜46C illustrates a schematic diagram of a spillway of the mold apparatus of the lens array in accordance with another embodiment of the present invention.

### DETAILED DESCRIPTION OF PREFERRED EMBODIMENTS

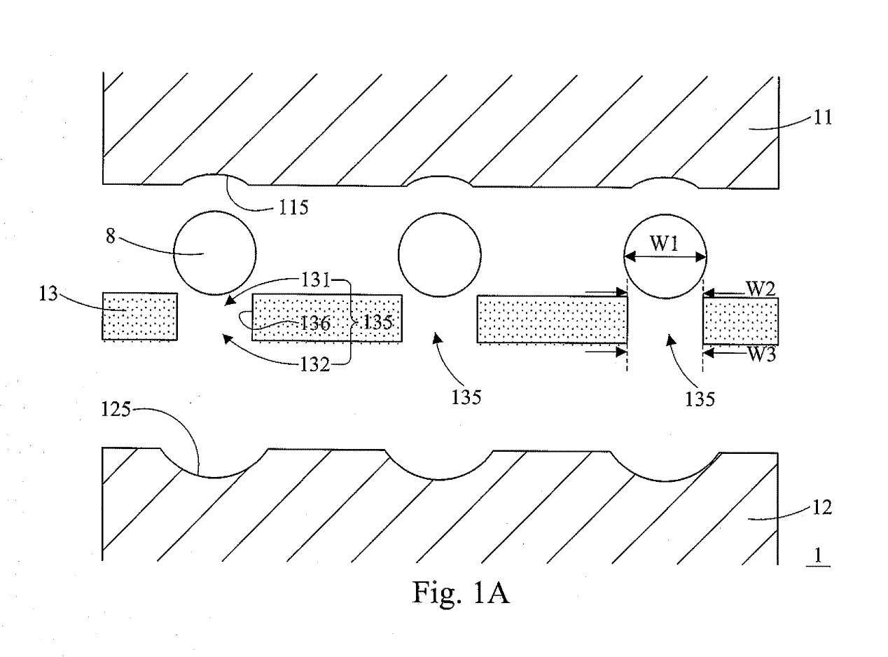

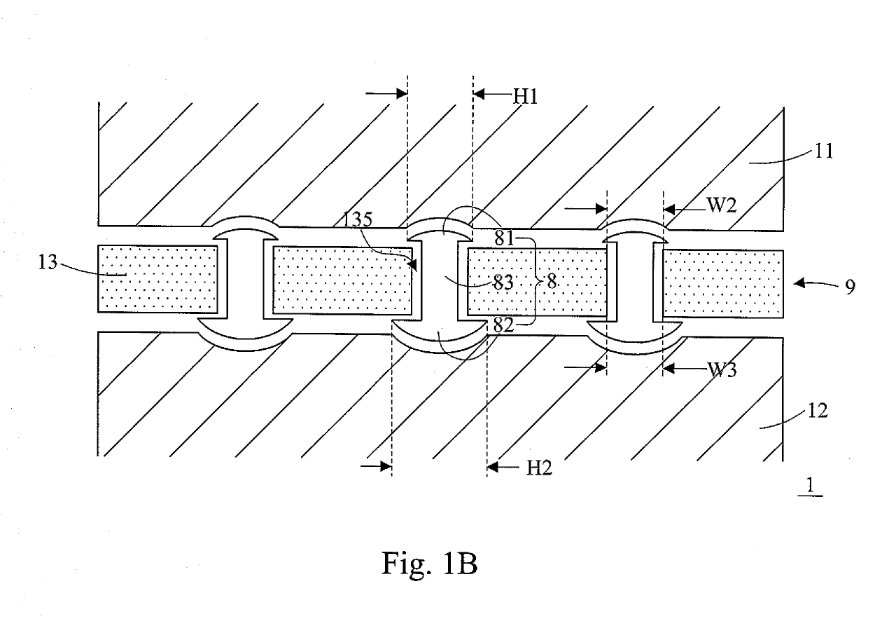

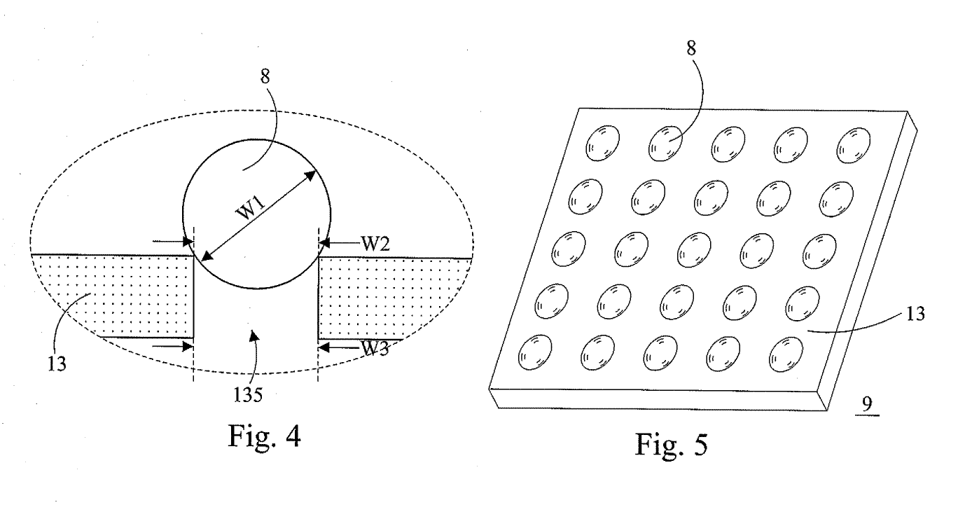

Please refer to FIG. 1A and FIG. 1B. FIG. 1A illustrates a schematic diagram of a mold apparatus of a lens array before approaching the upper pressing die and the lower pressing die according to the present invention. FIG. 1B illustrates a schematic diagram of the mold apparatus of the lens array after approaching the upper pressing die and the lower pressing die according to the present invention. The mold apparatus 1 of the lens array 9 of the present invention includes an upper pressing die 11, a lower pressing die 12 and a plate structure 13. The upper pressing die 11 includes a plurality of upper engaging portions 115. The lower pressing die 12 includes a plurality of lower engaging portions 125. The plate structure 13 is movably disposed between the upper pressing die 11 and the lower pressing die 12. Specifically, not only the plate structure 13 could be disposed between the upper pressing die 11 and the lower pressing die 12 but also the plate structure 13 could be taken away from the upper pressing die 11 and the lower pressing die 12. The plate structure 13 includes a plurality of through holes 135 disposed thereon. A glass article 8 can be installed at each through holes 135. The glass article 8 includes a first sectional width W1. The first sectional width W1 is a maximum horizontal intercept of the glass article 8 demonstrated in the FIG. 1A. In the embodiment of FIG. 1A, the glass article 8 is spherical, therefore the first sectional width W1 of the glass article 8 is equal to the diameter of the glass article 8. The through hole 135 includes an upper opening 131 and a lower opening 132. The upper opening 131 corresponds to the upper pressing die 11. The lower opening 132 corresponds to the lower pressing die 12. The upper opening 131 includes a second sectional width W2. The second sectional width W2 is a horizontal intercept of the upper opening 131 depicted in the FIG. 1A. The lower opening 132 includes a third sectional width W3. The third sectional width W3 is a horizontal intercept of the lower opening 132 depicted in the FIG. 1A. As shown in FIG. 4, W1≧W2 or W1≧W3. In this manner, the glass article 8 can enter the through hole 135 or be stuck in the through hole 135 when the glass article 8 is approached, rolled to or disposed in the through hole 135. Therefore, at least part of the volume of the glass article 8 can be disposed in the through hole 135. The material of the plate structure 13 can be metal, alloy, ceramic, glass and polymer composite material. The plate structure 13 is movably deposed between the upper pressing die 11 and the lower pressing die 12; therefore, the plate structure 13 could be selectively taken away from some molding process or some other manufacturing steps. In this manner, either the pre-processing operation or the post-processing operation through the plate structure 13 or the glass articles 8 is absolutely made. Noticed that, the upper pressing die 11 could be disposed above the lower pressing die 12 or beneath the lower pressing die 12, or even that the upper pressing die 11 and the lower pressing die 12 can also be disposed on the same horizontal plane.

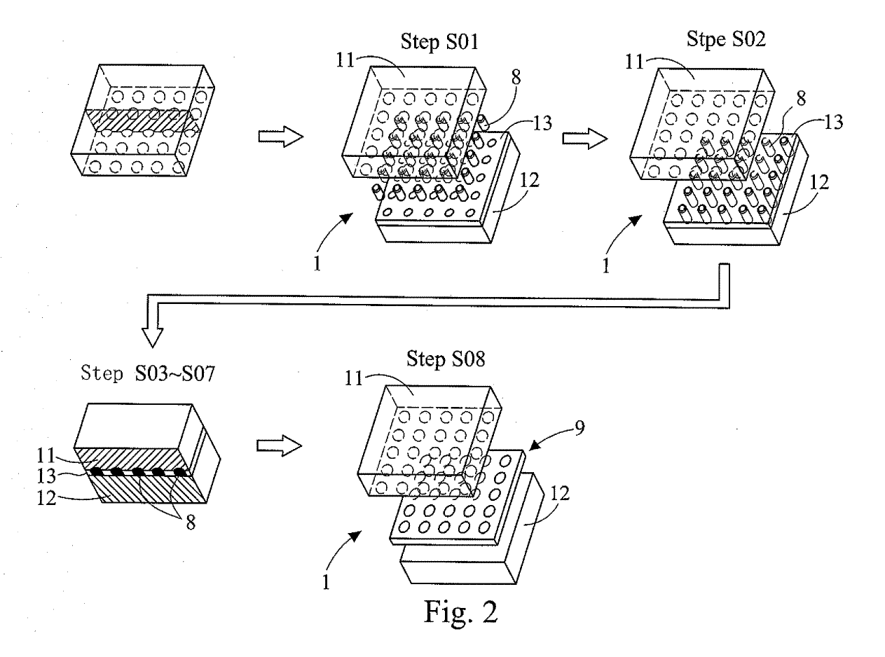

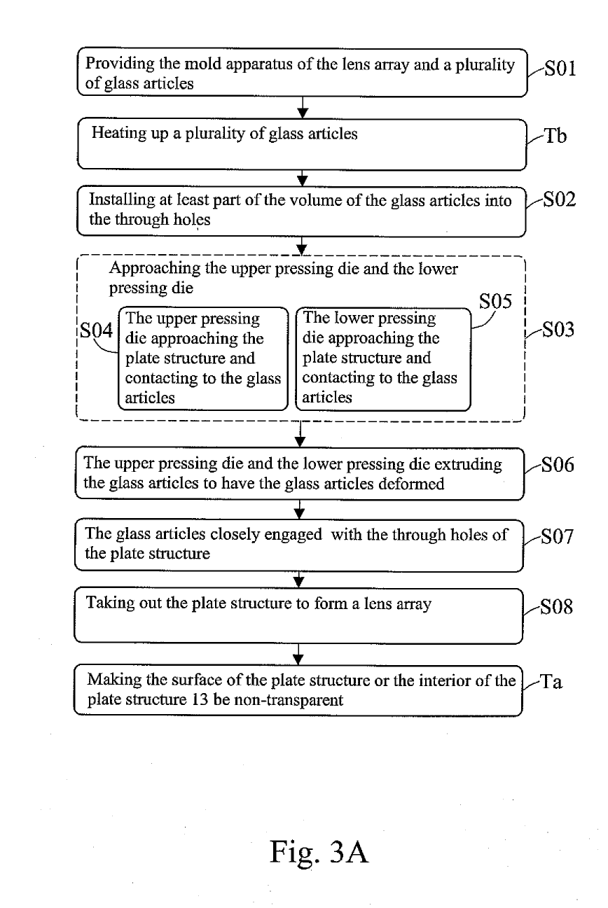

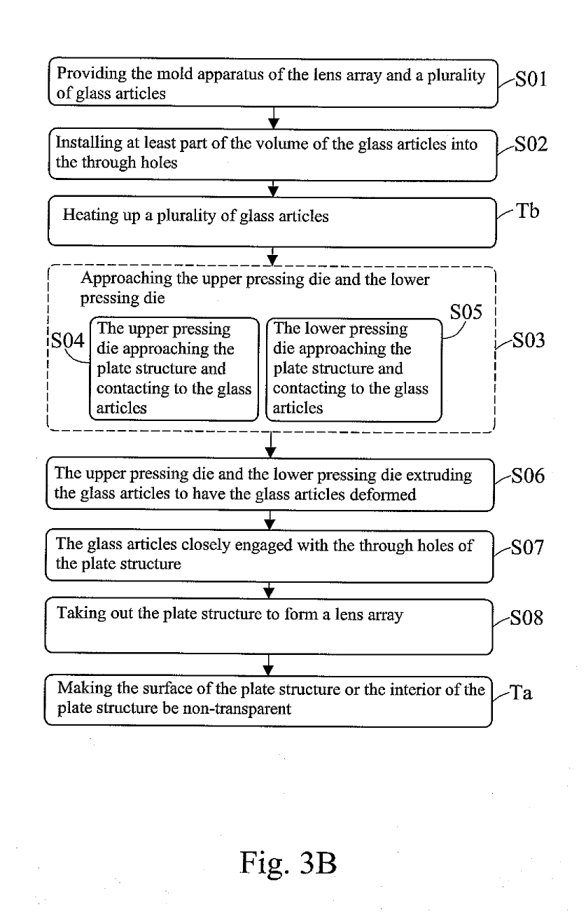

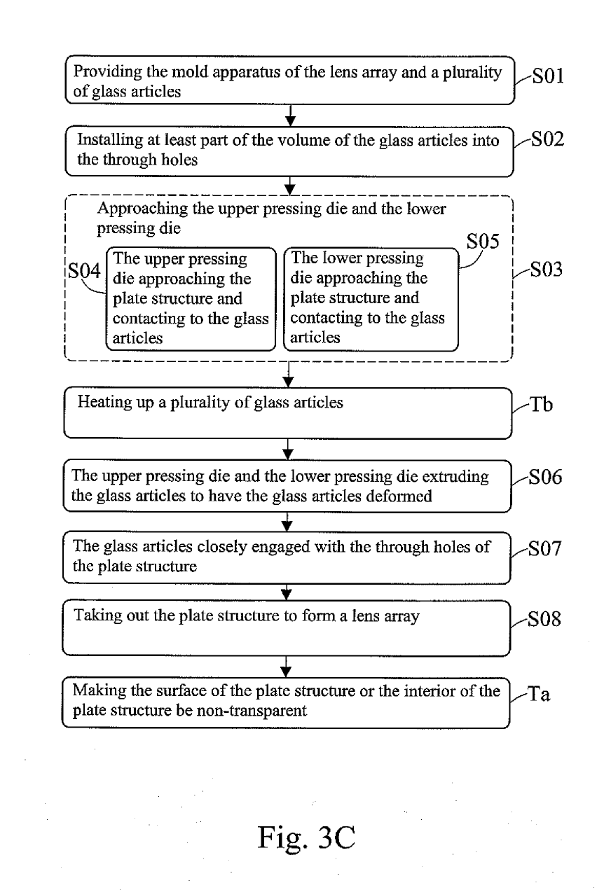

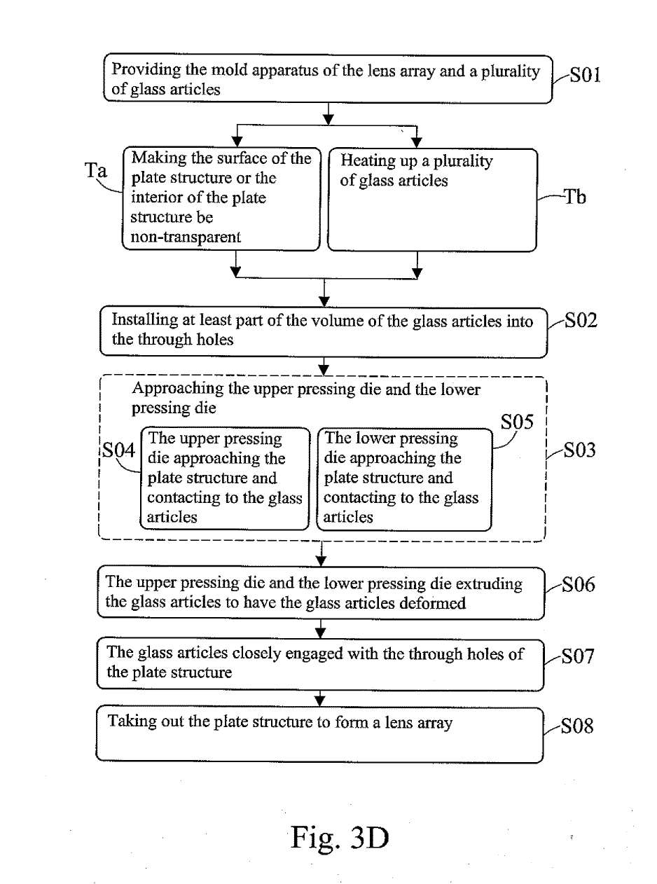

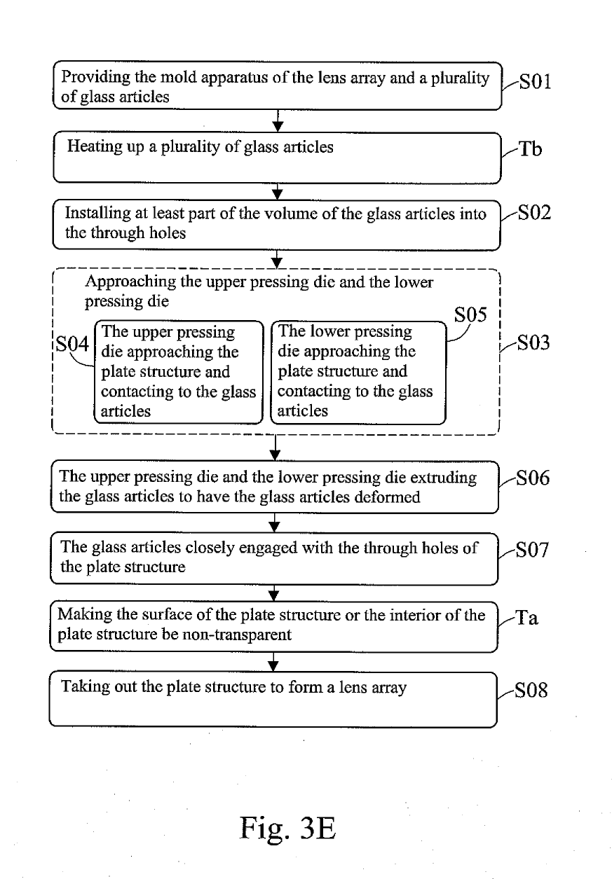

Please refer to FIG. 2 and FIG. 3A. FIG. 2 illustrates a flow chart of a method for using the mold apparatus of the lens array according to the present invention. FIG. 3A illustrates a flow chart of one of the method for using the mold apparatus of the lens array. The method for manufacturing the lens array 9 comprises the following steps: first, as described in the step S01, providing the mold apparatus 1 of the lens array 9 and a plurality of glass articles 8; next, as described in the step Tb, heating up a plurality of glass articles 8; next, as described in the step S02, disposing at least part of the volume of the glass article 8 into the through hole 135. Specifically, the step S02 may utilize a mechanical arm to grip and drop the glass article 8 into the through hole 135, or make the glass articles 8 roll, slip or move to enter the through hole 135. As a result, either at least part or all of the volume of the glass article 8 is hence disposed in the through hole 135. In the FIG. 4, only the low half of the glass articles 8 is disposed in the through hole 135; the upper half of the glass articles 8 is disposed outside the through hole 135. In another embodiment of the present invention, if the first sectional width W1 is roughly equal to the second sectional width W2 or the third sectional width W3, all volume of the glass articles 8 could be disposed in the through hole 135. Moreover, the glass articles 8 heated of the step Tb is carried out prior to the disposal of the glass articles 8 implemented in the step S02. In this manner, the glass articles 8 can be pre-heated up to 200˜1500° C. (the temperature is depended on the material of the glass articles 8.), to make the glass articles 8 soften and formable; the softened glass articles 8 are shaped easily. Therefore, there's no need to set the entire mold apparatus 1 in heating equipment.

Next, as described in the step S03, approaching the upper pressing die 11 and the lower pressing die 12. The step S03, including Step S04 and S05, has the step of approaching the upper pressing die 11 to the plate structure 13 so as to contact the glass articles 8 (Step S04), and the step of approaching the lower pressing die 12 to the plate structure 13 so as to contact the glass articles 8 (Step S05). Therefore the upper engaging portions 115 are disposed adjacent to the upper opening 131 and contacted to the glass article 8, and the lower engaging portions 125 are disposed adjacent to the lower opening 132 and contacted to the glass article 8, when the upper pressing die 11 and the lower pressing die 12 approaches to each other. Then, as described in the step S06, the upper pressing die 11 and the lower pressing die 12 may extrude the glass articles 8 to have the glass articles 8 deformed. In the FIG. 1B, the glass articles 8 are extruded to form an upper end portion 81, a body portion 83 and a lower end portion 82. The upper end portion 81 and the lower end portion 82 are disposed at two ends of the through hole 135. The body portion 83 is disposed in the through hole 135. Specifically, the profile of the upper end portion 81 of the glass articles 8 is formed via extrusion of the upper engaging portions 115; the profile of the lower end portion 82 is formed via extrusion of the lower engaging portions 125. Therefore, the profile of the upper end portion 81 will be the same as profile of the upper engaging portion 115; the profile of the lower end portion 82 will be the same as profile of the lower engaging portion 125. Furthermore, as described in the step S07, the body portion 83 and the through hole 135 of the plate structure 13 are connected to each other after the glass article 8 is extruded. As a result, the step S07 could ensure that the glass articles 8 and the plate structure 13 will not be loosened, swayed or departed. Practically, the step S05 might also be prior to the step S04, or concurrently implemented to the step S04.

As demonstrated in the FIG. 1A, the volume of the glass article 8 is greater than or equal to the space occupied by the through hole 135 (i.e. volume of through hole 135). Therefore, as depicted in the FIG. 1B, the upper end portion 81 is extruded and disposed outside the upper opening 131 of the through hole 135, and the lower end portion 82 is extruded and disposed outside the lower opening 132 of the through hole 135. Therefore, the lateral width H1 of the upper end portion 81 is greater than the second sectional width W2 of the upper opening 131, and the lateral width H2 of the lower end portion 82 is greater than the third sectional width W3 of the lower opening 132. As a result, the glass article 8 is engaged and firmly connected to the plate structure 13 without loosening, swaying or departing.

As described in the step S08, a lens array 9 (referring to the FIG. 5) is formed with a plurality of the glass articles 8 after the plate structure 13 is taken away from the mold apparatus 1, and it is shown that the glass articles 8 are filled in the through holes 135 of the plate structure 13. The glass article 8 is a transparent structure, such as glass, thus the light ray can pass through the glass articles 8. Normally, the material, index of refraction or glass transition temperature (Tg) of the glass articles 8 in a lens array 9 are all the same. In some other embodiments, different materials, different composition of materials, different index of refractions or different glass transition temperatures (Tg) of glass articles 8 may also be applied in a lens array 9.

Next, as described in the step Ta, making the surface of the plate structure 13 or the interior of the plate structure 13 be non-transparent. Specifically, the plate structure 13 becomes non-transparent may through surface coating method, surface blasting method, atomizing surface method, or internal doping method. Furthermore, the step Ta could be optionally carried out according to different situations, or even implemented prior to one of the previous steps.

Therefore, the method for using the mold apparatus 1 of the lens array 9 revealed in the FIG. 3A take advantage of the profile of the upper engaging portions 115 and the lower engaging portions 125, to extrude the glass articles 8 and then form a perfect curve. In addition, the internal refractive index of the lens array 9 could be homogenized or pre-designed because the glass article 8 utilized could be selected in advance. As a result, the production yield or production capacity of the glass lens array 9 could be improved. Moreover, as described in the step Tb, the glass articles 8 in the FIG. 3A can be heated and then cooled down slowly in the mold apparatus 1, so as to prevent rapid cooling occurred or temperature gradient generated, hence the temperature gradient normally cause unwanted residual thermal stress. Furthermore, because the glass articles 8 are extruded and pressed in a high temperature state, the mechanical stress or concentration stress would be significantly reduced. In summary, the method for using the mold apparatus I of the lens array 9 of the present invention has an excellent commercial potential.

Please refer to FIG. 3B. In contrast to the FIG. 3A, the glass article 8 revealed in the step Tb is heated later than glass articles 8 disposed step S02. In the scenario of FIG. 3B, the glass article 8 and the plate structure 13 can be moved and transported easily (because not yet heated) if the glass articles 8 are disposed on the through hole 135 of the plate structure 13. It may also have advantage of applying different volumes, different shapes, and different refractive indexes of glass articles 8 heated up concurrently and homogeneously. Different heating rate or different temperature in different glass articles 8 is unable to happen.

Please refer to FIG. 3C. In contrast to the FIG. 3B, the heating step Tb is later than the step S03. In this manner, the glass article 8 could be extruded and heated concurrently, so as to achieve homogenizing the internal refractive index of the glass articles 8.

Please refer to FIG. 3d. In contrast to the FIG. 3A, the step Ta is prior to the approached step S03 and the extruded step S06. In this manner, the plate structure 13 is immediately implemented the surface coating method, surface blasting method, atomizing surface method or internal doping method after the mold apparatus 1 and the plate structure 13 is provided. Furthermore, the step Ta could be implemented earlier than or later than the heating step Tb, or both of them may also be carried out simultaneously. Therefore, the method for using the mold apparatus 1 of the lens array 9 could have higher flexibility.

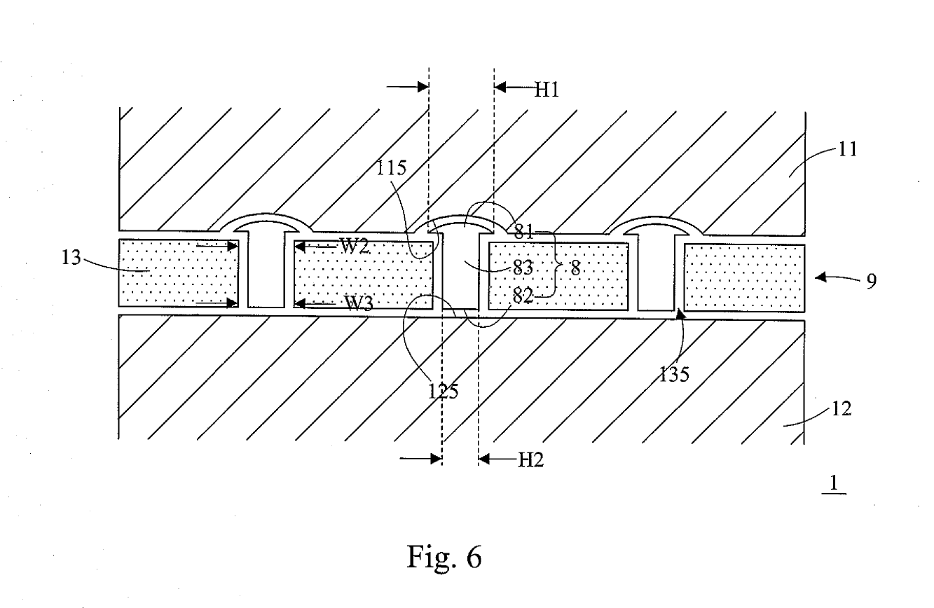

Please refer to FIG. 6-9. The FIG. 6-9 illustrates a schematic diagram of the mold apparatus of the lens array after approaching the upper pressing die and the lower pressing die in accordance with another embodiment of the present invention. As depicted in the FIG. 6, the upper engaging portion 115 covers whole area of the upper opening 131 (i.e. upper of the through hole 135.) and the lower engaging portion 125 entirely covers the lower opening 132 (i.e. lower of the through hole 135.) when the upper pressing die 11 and the lower pressing die 12 approach to the plate structure 13 and the glass articles 8. Besides, the volume of the glass article 8 is greater than the space occupied by the through hole 135, therefore the upper end portion 81 of the glass article 8 is extruded outside the through hole 135 after the upper pressing die 11 approaches to the plate structure 13. As a result, the lateral width H1 of the upper end portion 81 is greater than the second sectional width W2 of the through hole 135 after the glass article 8 is extruded. Moreover, the lateral width H2 of the lower end portion 82 is about equal to the third sectional width W3 of the through hole 135. In addition, the shape of the upper engaging portion 115 is different from the shape of the lower engaging portions 125, or the area of the upper engaging portion 115 is different from the area of the lower engaging portions 125. The, upper engaging portion 115 of the upper pressing die 11 presents as a concave, therefore the upper end portion 81 of the glass article 8 will consequently presents as a protruding shape after the glass article 8 is extruded. The lower engaging portions 125 of the lower pressing die 12 presents as a flat shape, and hence the lower end portion 82 of the glass article 8 will consequently presents as a flat shape after the glass article 8 is extruded. In some other embodiment, the upper engaging portion 115 could alternatively be a protruding shape or a flat shape, or the lower engaging portions 125 could alternatively be a protruding shape or a concave. Besides, the profile of the upper engaging portion 115 and the profile of the lower engaging portions 125 could be exchanged.

Please refer to FIG. 7. Because the area of the upper engaging portion 115 is roughly equal to the area of the upper opening 131 of the through hole 135, the upper engaging portion 115 completely covers the upper opening 131. Because the area of the lower engaging portions 125 is roughly equal to the area of the lower opening 132 of the through hole 135, the lower engaging portion 125 completely covers the lower opening 132. In the present embodiment, the upper engaging portion 115 presents as a protruding shape, and as a result the upper end portion 81 may present as a concave after the glass article 8 is extruded. The lower engaging portions 125 presents as a concave and as a result the lower end portion 82 may present as a protruding shape after the glass article 8 is extruded. As depicted in FIG. 7, the through hole 135 is columnar, thus the second sectional width W2 of the upper opening 131 is equal to the third sectional width W3 of the lower opening 132, and the lateral width H1 of the upper end portion 81 is equal to the lateral width H2 of the lower end portion 82.

Please refer to the mold apparatus 1 demonstrated in the FIG. 8. The upper engaging portion 115 located in the middle completely covers the upper opening 131 of the through hole 135, and the lower engaging portion 125 in the middle barely covers the area of the lower opening 132. Namely, the area of the upper engaging portion 115 in the middle is greater than the area of the corresponding lower engaging portion 125. As a result, the lateral width H1 of the upper end portion 81 is about equal to the second sectional width W2 of the upper opening 131, and the lateral width H2 of the lower end portion 82 is less than the third sectional width W3 of the lower opening 132 after the middle glass article 8 is extruded. Further, the area of the upper engaging portion 115 on both left and right sides is equal to the area of the corresponding lower engaging portion 125, but the upper engaging portion 115 presents as a concave and the lower engaging portions 125 presents as a protruding shape. Therefore, the profile of the glass article 8 in the middle is different from the profile of the glass article 8 on the both left and right sides after three glass articles 8 are extruded.

Please refer to the mold apparatus 1 depicted in the FIG. 8. The through hole 135 is conical; therefore the second sectional width W2 of the through hole 135 is different from the third sectional width W3 of the through hole 135. In the present embodiment, the lateral width HI of the upper end portion 81 could be greater than, equal to or less than the lateral width H2 of the lower end portion 82. Actually, the size of the lateral width H1 and the lateral width H2 will depend on the profiles of the upper engaging portion 115 and the profiles of the lower engaging portions 125.

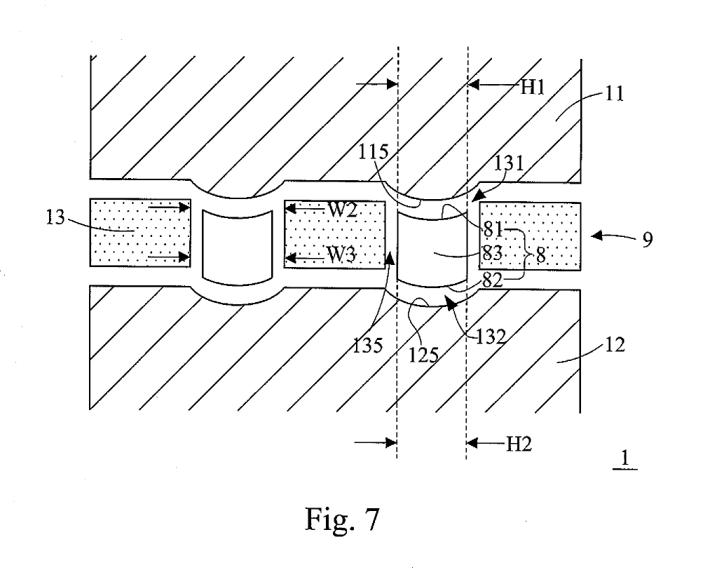

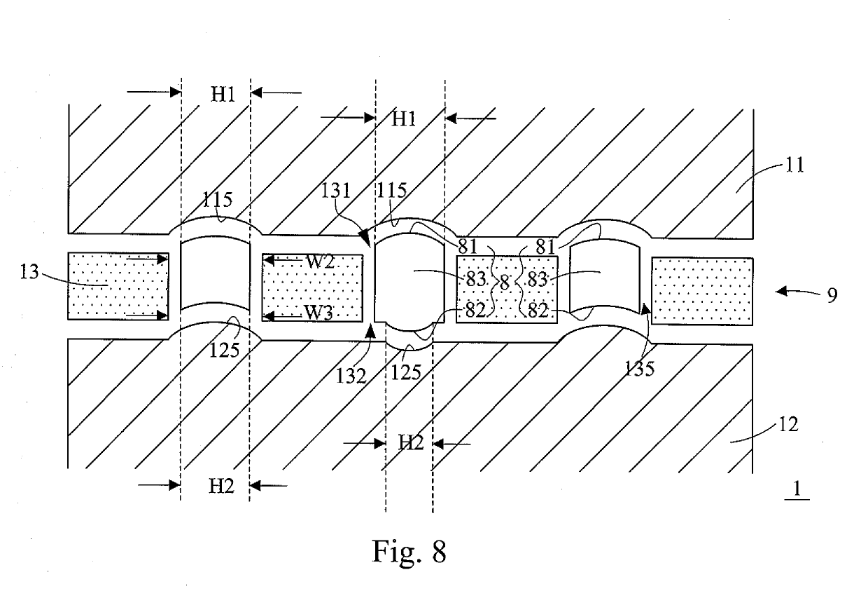

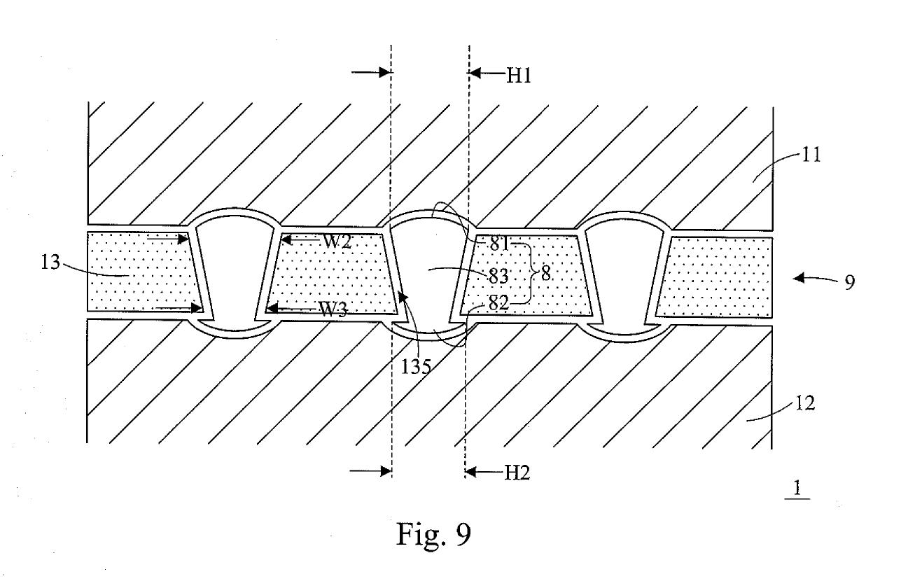

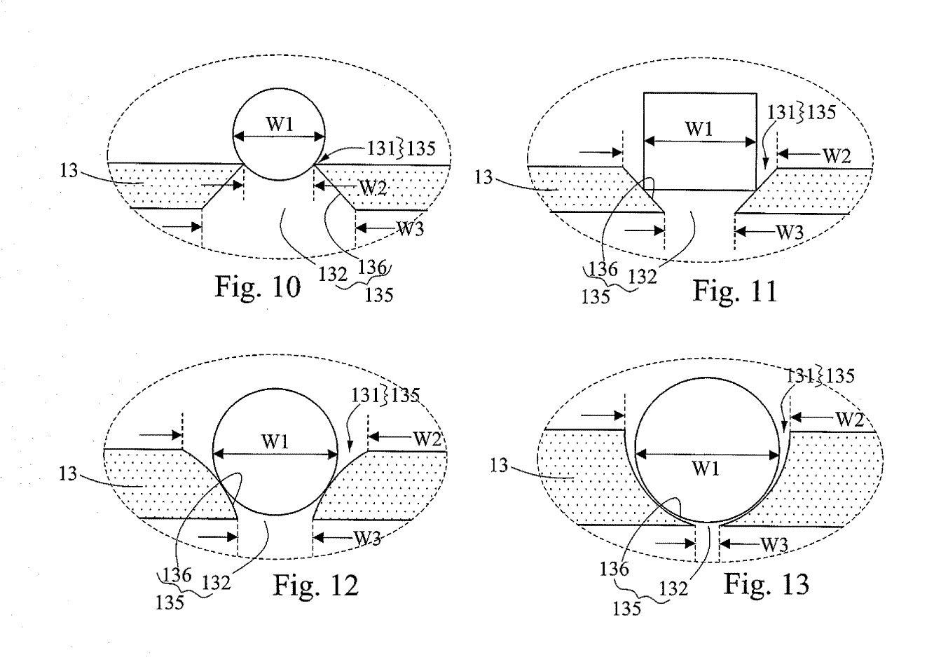

In this, introducing a corresponding position of the glass articles 8 and the plate structure 13 is in the step S02 (Before approaching). Please refer to FIG. 10˜13. The FIG. 10˜13 illustrates a schematic diagram of the glass article corresponding to the plate structure in accordance with another embodiment of the present invention. As shown in FIG. 10, the shape of the glass article 8 presents as a spherical ball, and the first sectional width W1 (i.e. the diameter of the ball.) of the glass article 8 is greater than the second sectional width W2 of the upper opening 131 of the through hole 135. Therefore the glass article 8 is stuck at the upper opening 131, with the low half of the glass articles 8 disposed in the through hole 135. As a result, it is easy to move the plate structure 13 and a plurality of glass articles 8 for some other subsequent manufacturing steps with convenience. In the present embodiment, the shape of the upper opening 131 of the through hole 135 is different from the shape of the lower opening 132 of the through hole 135, and the area of the upper opening 131 is less than the area of the lower opening 132 (the second sectional width W2 is less than the third sectional width W3). Specifically, the through hole 135 includes a bore wall 136. The bore wall 136 is connected to the upper opening 131 and the lower opening 132. The upper opening 131 has area less than the lower opening 132. A sectional view of the bore wall 136 presents as a straight line. Therefore, the through hole 135 is a conical space. As depicted in the FIG. 11, the glass article 8 is a columnar structure. Because the first sectional width W1 of the glass article 8 is greater than the third sectional width W3 of the lower opening 132 of the through hole 135, the low half of the glass articles 8 could be stuck and disposed in the through hole 135. As a result, it is easy to move the plate structure 13 and a plurality of glass articles 8 as some manufacturing steps needed. In the present embodiment, the area of the upper opening 131 of the through hole 135 is greater than the area of the lower opening 132 (the second sectional width W2 is greater than the third sectional width W3), and the through hole 135 is an inverse conical space. Please refer to FIG. 12 and FIG. 13. The through hole 135 of the present embodiment is also an inverse conical space. Because the area of the upper opening 131 of the through hole 135 is greater than the area of the lower opening 132, most of the volume of the glass articles 8 could be disposed or stuck inside the through hole 135. Furthermore, the sectional view of the bore wall 136 in the FIG. 12 and FIG. 13 is a curve, with the bending direction of the each bore wall 136 different.

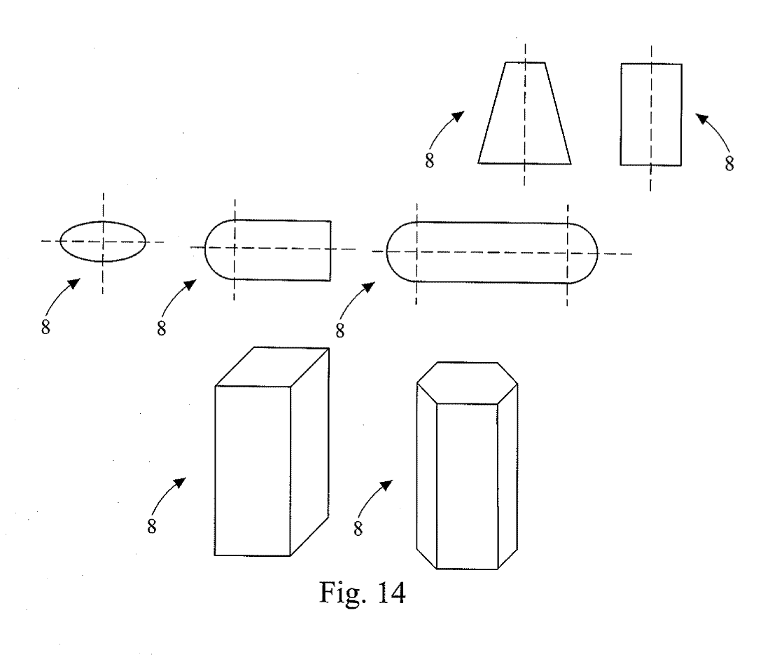

In the present invention, the glass articles 8 could have a plurality of different shapes. Please refer to the FIG. 14. FIG. 14 illustrates a schematic diagram of different shapes of the glass articles. The sectional view of the glass articles 8 could be oval-shaped, taper, rectangular (e.g. rectangular prisms, hexagonal prisms, or cylinders), square-shaped or irregular-shaped etc.

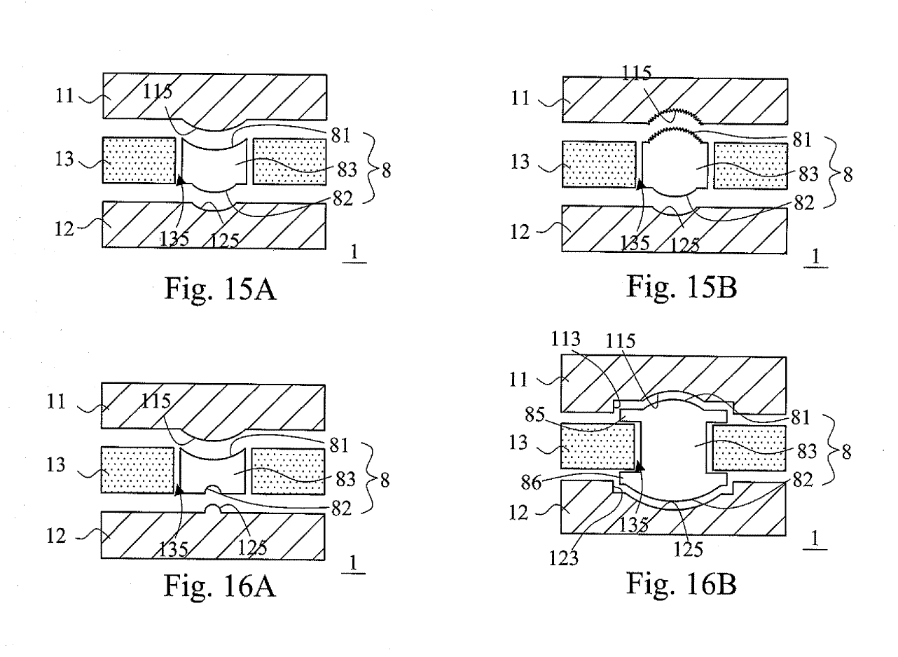

Please refer to FIG. 15A˜16B. The FIG. 15A˜16B illustrates a schematic diagram of the mold apparatus of the lens array after approaching the upper pressing die and the lower pressing die in accordance with another embodiment of the present invention. Please refer to the FIG. 15A, the area of the upper engaging portion 115 is greater than the area of the lower engaging portion 125, therefore the surface area of the upper end portion 81 is greater than the surface area of the lower end portion 82 after the glass article 8 is extruded. Furthermore, the upper engaging portion 115 entirely covers the upper opening 131, and the lower engaging portion 125 barely covers a part of the lower opening 132. In addition, the upper engaging portion 115 is a projecting structure, and as a result the upper end portion 81 is consequently a concave structure after the glass article 8 is extruded. As depicted in the FIG. 15B, the upper engaging portion 115 is a Fresnel-lens structure, and therefore the upper end portion 81 of the glass article 8 presents as a Fresnel lens structure after the glass article 8 is extruded. Because both the upper end portion 81 and the lower end portion 82 of the glass article 8 are a projecting structure, the glass article 8 may present a lenticular lens after the glass articles 8 is extruded. In another embodiment, the Fresnel lens structure could be disposed at the lower engaging portion 125. As depicted in the FIG. 16A, the upper engaging portion 115 entirely covers the upper opening 131 and the lower engaging portion 125 barely covers part of the lower opening 132. Because both the upper end portion 81 and the lower end portion 82 of the glass article 8 present as a concave, the glass article 8 is a double concave lens. As depicted in the FIG. 16B, two sides of the upper engaging portion 115 further includes two extending regions 113, and two sides of the lower engaging portion 125 include two extending regions 123. After the upper pressing die 11 and the lower pressing die 12 approach to the plate structure 13, the extending regions 113 and the extending regions 123 are not directly connected to the through hole135. Namely, there is a small distance from the extending region 113 or the extending region 123 to the through hole135. As a result, two sides of the upper end portion 81 can form two extending portions 85, and two sides of the lower end portion 82 can also form two extending portions 86, after the glass article 8 is extruded. In this manner, the plate structure 13 is hence clamped by the extending portions 85 and the extending portions 86, thus the glass article 8 can be firmly engaged and connected to the plate structure 13; no need to worry about loosened, swayed or departed event.

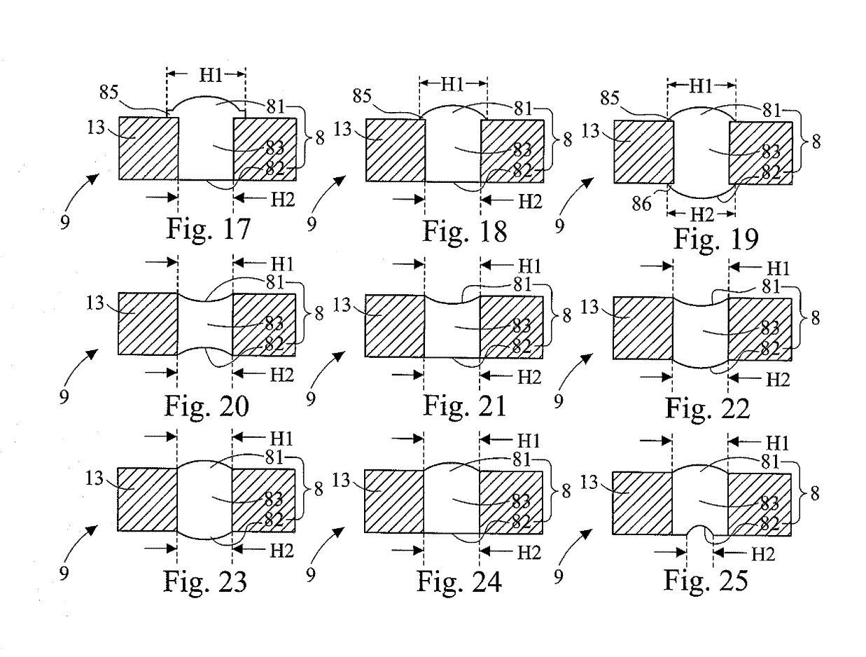

Please refer to FIG. 17˜25. The FIG. 17˜25 illustrates a schematic diagram of combining the glass article with the plate structure in accordance with another embodiment. As shown in the FIG. 17, two sides of the upper end portion 81 includes two extending portions 85, but the lower end portion 82 does not include it. The bottom edge of the lower end portion 82 and the bottom edge of the plate structure 13 are on the same horizontal plane. As shown in the FIG. 18, the glass article 8 is formed into a lens structure having top being a projecting structure and bottom being a flat structure. Because two sides of the upper end portion 81 includes two extending portions 85, the lateral width H1 of the upper end portion 81 is greater than the second sectional width W2 of the through hole 135. As shown in the FIG. 19, the glass article 8 is formed a lenticular lens having top and bottom being a projecting structure. Besides, the glass article 8 has the extending portions 85 and the extending portions 86 for fixing purpose. The glass article 8 of the FIG. 20 forms a double concave lens, with top and bottom of the glass article 8 been concave structures. The glass article 8 of the FIG. 21 forms a lens structure, with top of the glass article 8 been a concave structure and bottom of the glass article 8 been a flat structure. The glass article 8 of the FIG. 22 forms a concavo-convex lens, with top of the glass article 8 been a concave structure and bottom of the glass article 8 been a projecting structure. The glass article 8 of the FIG. 23 forms a lenticular lens, with top and bottom of the glass article 8 been a projecting structure; however, the glass article 8 of the FIG. 23 does not include the extending portions 85 and the extending portions 86. The glass article 8 of the FIG. 24 also forms a lens structure, with top of the glass article 8 been a projecting structure and bottom of the glass article 8 been a flat structure; besides, the upper end portion 81 of the glass article 8 of the FIG. 24 does not include the extending portions 85. The glass article 8 of the FIG. 25 forms a concavo-convex lens, with top of the glass article 8 been a projecting structure and bottom of the glass article 8 been a concave structure; however, the area of the concave structure is less than the area of the projecting structure.

Please refer to FIG. 26˜31. The FIG. 23˜31 illustrates a schematic diagram of different types of the plate structures. Please refer to the FIG. 26, the shape of the upper opening 131 of the plate structure 13 is circular, and the shape of the lower opening 132 of the plate structure 13 is hexagonal. Namely the shape of the upper opening 131 is different from the shape of the lower opening 132. In addition, the shape of the upper opening 131 could be circular, oval-shaped, polygon-shaped (e.g., triangle, quadrangle, pentagon) or irregular-shaped. Of course the shape of the lower opening 132 could be circular, oval-shaped, polygon-shaped or irregular-shaped. Therefore the area of the upper opening 131 of the through hole 135 can be equal or unequal to the area of the lower opening 132 of the through hole 135. Please refer to the FIG. 27˜28, the upper opening 131 of the through hole 135 has area greater than the lower opening 132. Specifically the sectional view of the bore wall 136 may present as a straight line (FIG. 27) or a curve (FIG. 28). Please refer to the FIG. 29, the plate structure 13 includes a plurality of first through holes 135A and a plurality of second through holes 135B. The volume of the first through hole 135A is different from the volume of the second through hole 135B, or the shape of the first through hole 135A is different from the shape of the second through hole 135B. The first through holes 135A and the second through holes 135B are arranged regularly. Specifically, every circle is formed with the same type of through holes, and concentric circles are formed with a plurality of different types of through holes sequentially. Please refer to the FIG. 30, a plurality of first through holes 135A and a plurality of second through holes 135B are regularly arranged on the plate structure 13. Specifically, the same type of through holes is arranged in a straight line (e.g., vertical alignment or horizontal alignment). A plurality of different types of through holes is sequentially and alternately arranged. Please refer to the FIG. 31, the plate structure 13 includes the first through holes 135A, the second through holes 135B, a plurality of third through holes 135C, and a plurality of forth through holes 135D. Each type of the through hole has different shapes or volumes, and the same type of the through holes is arranged in concentric circles.

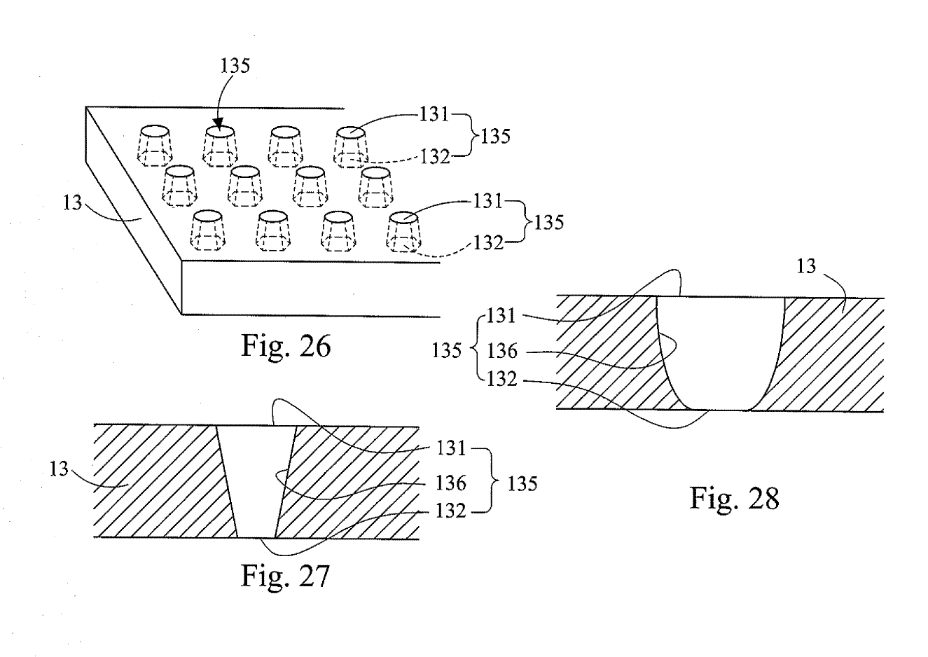

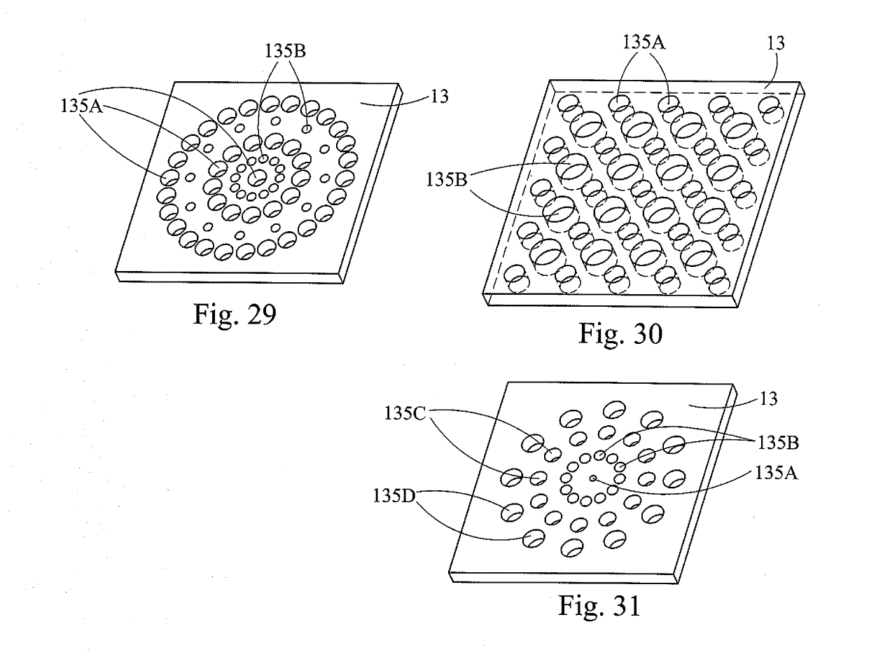

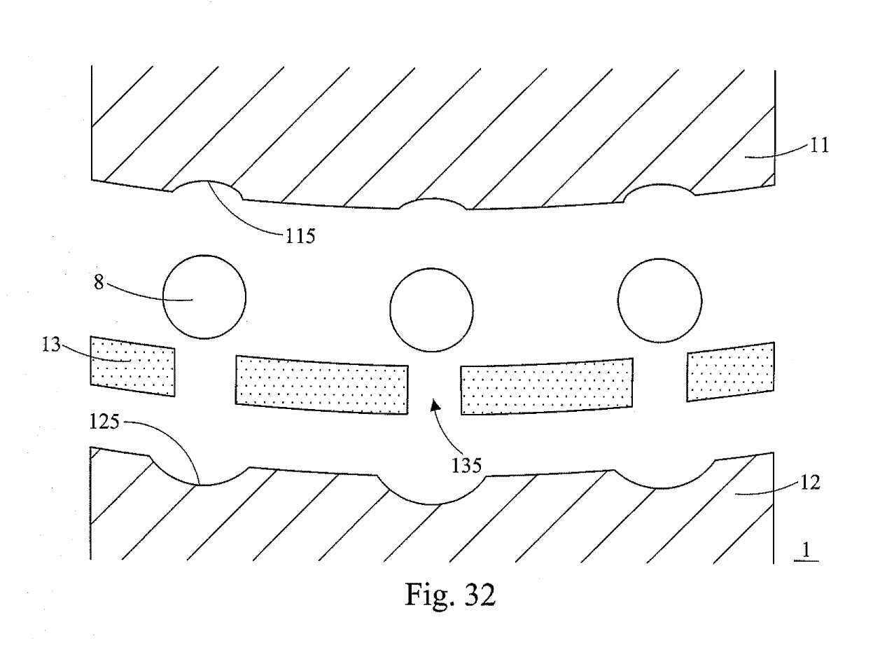

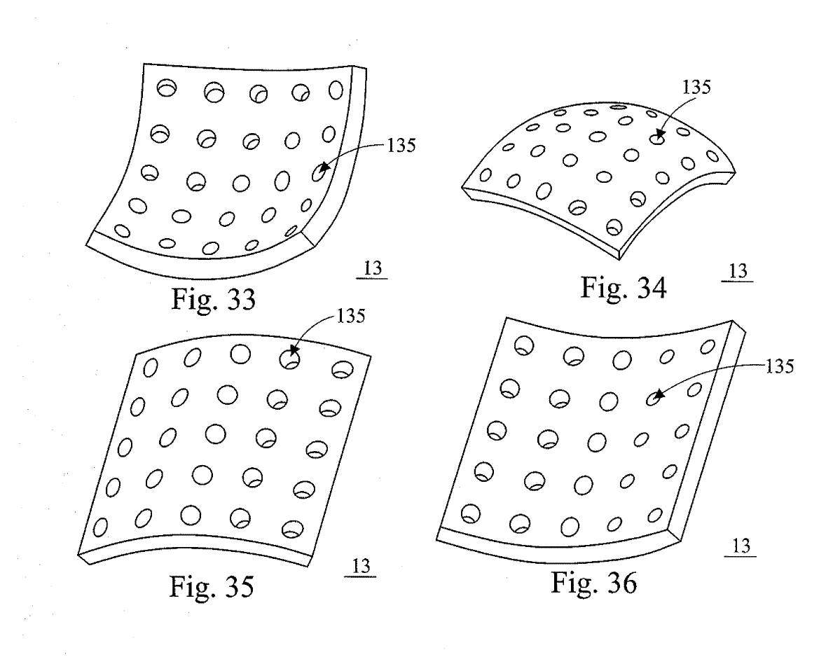

The mold apparatus 1 of the present invention may also form or process a curve or bending plate structure 13. Please refer to FIG. 32˜36. FIG. 32˜36 illustrates a schematic diagram of the plate structure presenting as a curve. As shown in FIG. 32, the plate structure 13 is curved or bended. The upper pressing die 11 and the lower pressing die 12 correspondingly have the same curvature to the plate structure 13.

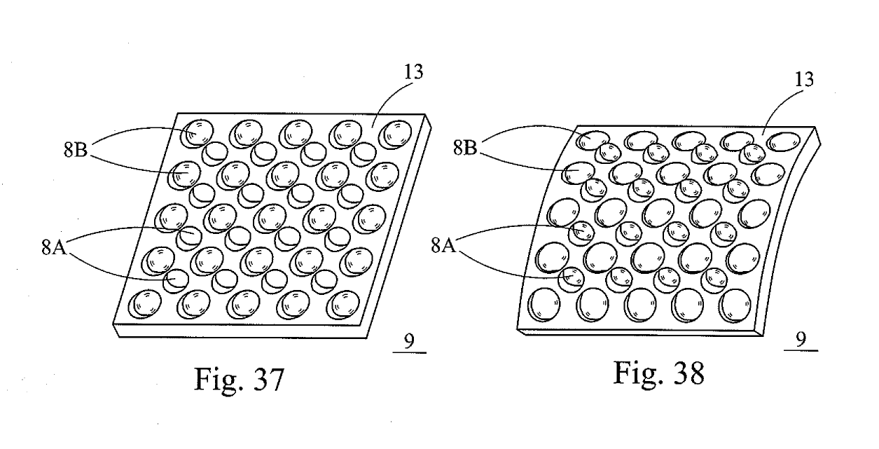

The lens array 9 processed could be formed as shown in the FIG. 37˜38 after molding process. The FIG. 37˜38 illustrates the schematic diagram of different types of the lens arrays. The lens array 9 of the FIG. 37˜38 includes a plurality of different volumes or different types of the glass articles 8. Specifically, the glass articles 8 may include a first configuration 8A and a second configuration 8B. The volume of the first configuration 8A is different from the volume of the second configuration 8B, or the shape of the first configuration 8A is different from the shape of the second configuration 8B. The glass articles 8 with the first configuration 8A and the glass articles 8 with the second configuration 8B are sequentially, alternately or regularly arranged. In other embodiment of the present invention, the glass articles 8 could further has a third configuration, a fourth configuration or other different configurations. Furthermore, a plurality of glass articles 8 may also have a plurality of different index of refractions. For example, the glass articles 8 may have a first index of refraction, a second index of refraction or a third index of refraction. In this manner, the glass articles 8 with a plurality of the different index of refractions then can be arranged sequentially, alternately or regularly. Moreover, a plurality of glass articles 8 includes a plurality of different glass transition temperatures. For example, the glass articles 8 may have a first glass transition temperature, a second glass transition temperature, or a third glass transition, or more. Then, the glass articles 8 with a plurality of different glass transition temperatures are arranged sequentially, alternately or regularly. In this embodiment, the plate structure 13 of the FIG. 37 is a flat structure and the plate structure 13 of the FIG. 38 is a curved plate structure.

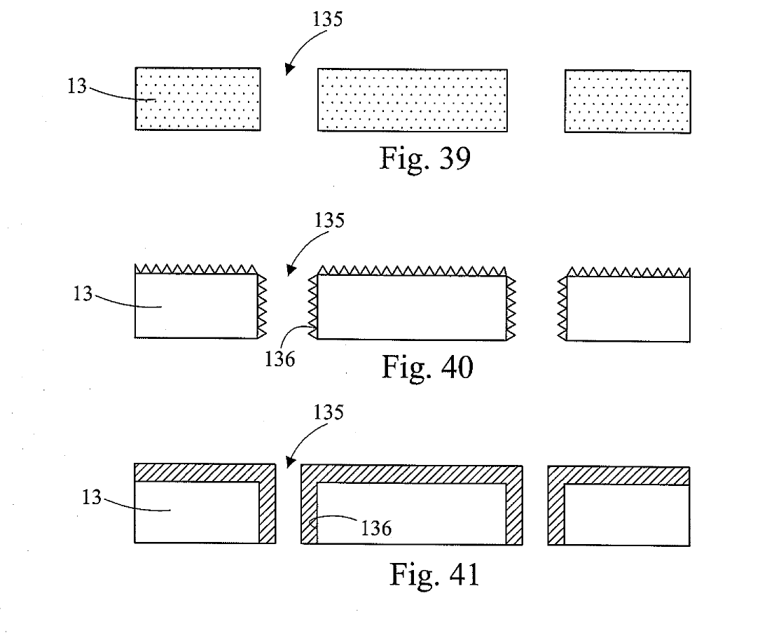

Certainly, the plate structure 13 of the mold apparatus 1 could also have different types. Please refer to FIG. 39˜41. FIG. 39˜41 illustrates a schematic diagram of the non-transparent plate structure. As shown in the FIG. 39, the interior of the plate structure13 is non-transparent by means of adding dye or an internal doping method. As shown in the FIG. 40, the plate structure 13 including the rim of the through holes 135 or the bore wall 136 can be treated with surface blasting method or an atomizing surface method, therefore have rough surface and achieve non-transparent. As shown in the FIG. 41, the plate structure13 is treated through surface coating method, so as to achieve non-transparent.

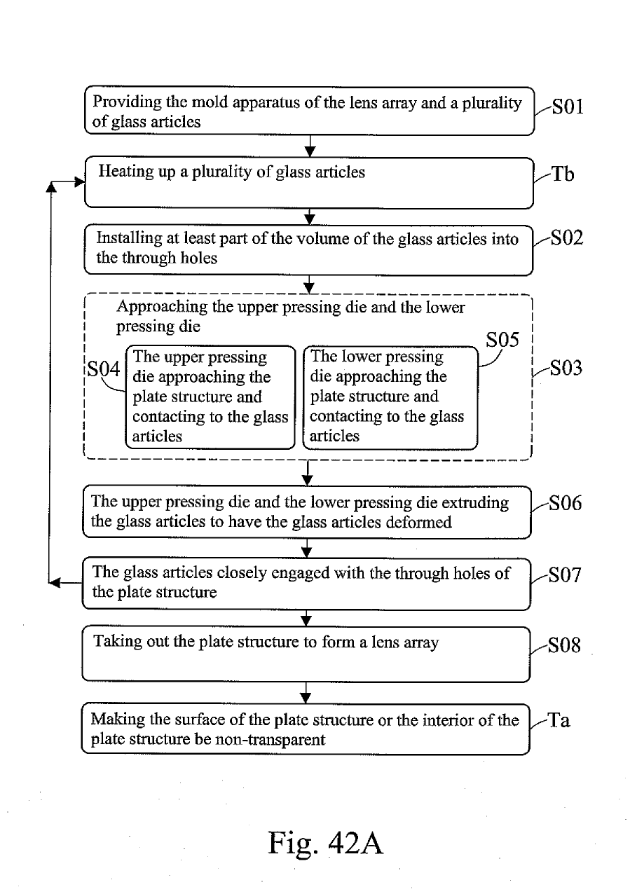

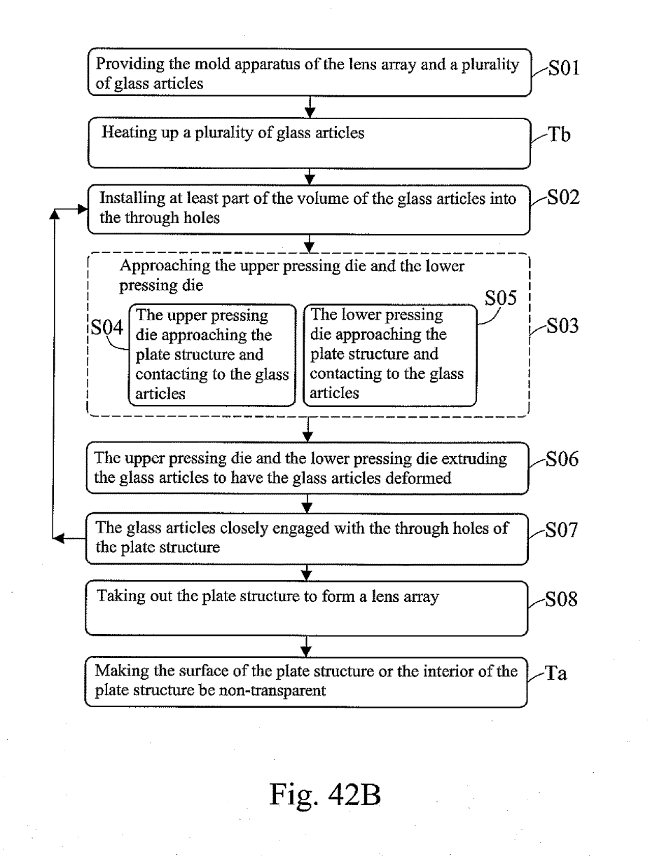

Please refer to FIG. 42A-42B. FIG. 42A-42B illustrates a flow chart of the method for using the mold apparatus of the lens array in accordance with another embodiment of the present invention. As shown in the FIG. 42A, in contrast to the FIG. 3A, the plate structure 13 could utilize different types of glass articles 8 in the flow chart of the FIG. 42A. In other words, there are several glass articles 8 with different glass transition temperatures waiting to process, namely those glass articles have a plurality of Tg value. In this embodiment, the glass articles 8 with higher Tg values need to be disposed on the plate structure 13 prior to the glass articles 8 with lower Tg values. In this manner the glass articles 8 with lower Tg value, tend to be melted and softened to stick the mold, will not suffered higher temperature while the mold apparatus 1 still in high temperature (lower Tg value tends to melt in lower temperature, and easier to stick to the mold). As shown in FIG. 42A, a first loop implementing the step Tb, the step S02, the step S03, the step S06 and the step S07 is made, to install the glass articles 8 with the highest Tg to the plate structure 13 and then extrude the these glass articles 8 to engaged with the plate structure 13. Afterward the second higher Tg glass articles 8 are made to implement the second loop (implementing step Tb, step S02, step S03, step S06 and step S07 again). And so on and so forth, the third loop or fourth loop can be carried out to process the glass articles 8 with 3rd Tg or 4th Tg by repeatedly implementing the step Tb, step S02, step S03, step S06 and step S07 again and again. As the result, the Tg value of glass articles 8 in the later loop will lower than the Tg value of glass articles 8 in the prior loop.

Please refer to FIG. 42B. The present invention is for approaching the different Tg values of glass articles 8 repeatedly. In contract to the FIG. 42A that the glass articles 8 with different Tg value are installed and extruded separately (in different loop of process), the glass articles 8 in FIG. 42B are heated up prior to the installing step S02 and extruding step S03 and S06; namely all glass articles 8 with different Tg are heated up simultaneously; afterward the glass articles 8 with high temperature are cooled down to several specific temperature stages, and then a loop (step S02, step S03, step S06 and step S07) is implemented once in each temperature stage. In this manner, the glass articles 8 with different temperature are installed to the through holes 135 in several different temperature stages. In the embodiment of the FIG. 42B, the glass articles 8 installed in the later loop must have lower Tg value than the glass articles 8 installed in the prior loop. In this manner, the glass article 8 with different Tg values could be separately installed on the plate structure 13, so as to install and arrange the glass articles 8 with different Tg values sequentially, alternately or regularly.

Noticed that, the upper pressing die 11, the lower pressing die 12, the upper engaging portion 115, the lower engaging portion 125, the upper opening 131, the lower opening 132, the bore wall 136, the plate structure 13, the first sectional width W1, the second sectional width W2, the third sectional width W3 or the space/structural features disclosed in the previous embodiments, as well as the profile, the material, the index of refraction and the arrangement of the glass articles 8, can be selectively and optionally applied to anyone of the aforementioned embodiments for sure. Therefore, the mold apparatus 1 of the lens array 9 and method for using the same of the present invention, could control the curvature of the surface profile of the glass lens array 9, and make the glass lens arrays 9 have perfect surface profile. Besides, every glass articles 8 extruded and processed may be homogenized, therefore the internal refractive index of the lens array 9 will achieve homogeneous, hence the production yield or production capacity of the glass lens array 9 is improved.

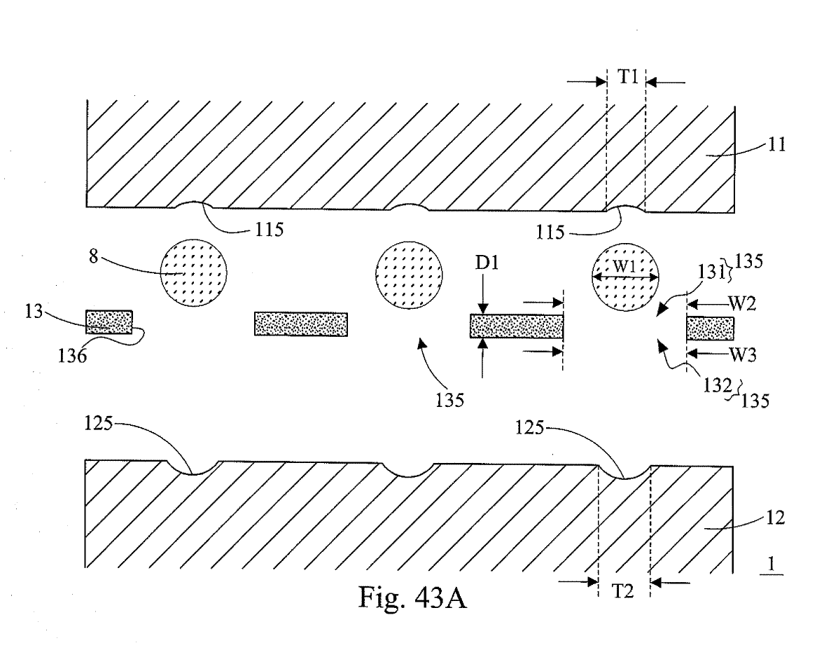

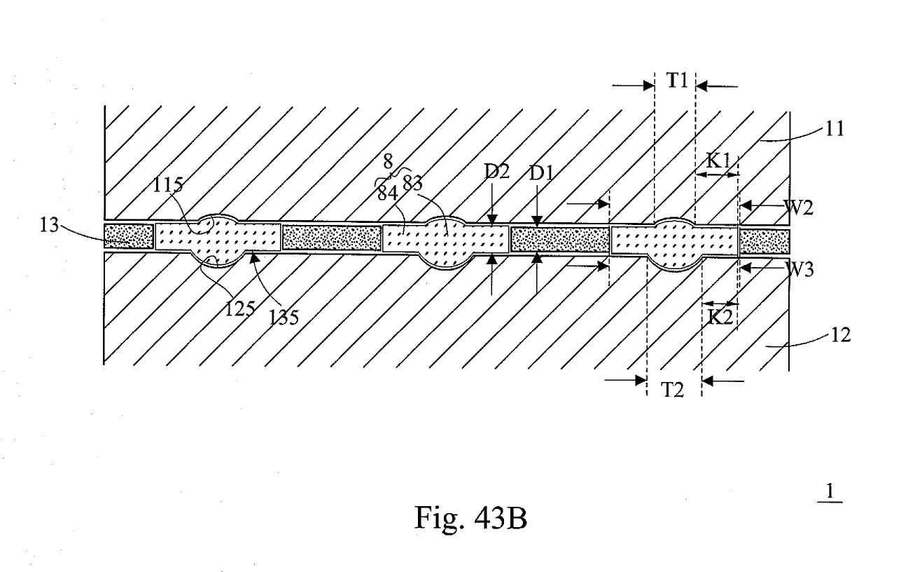

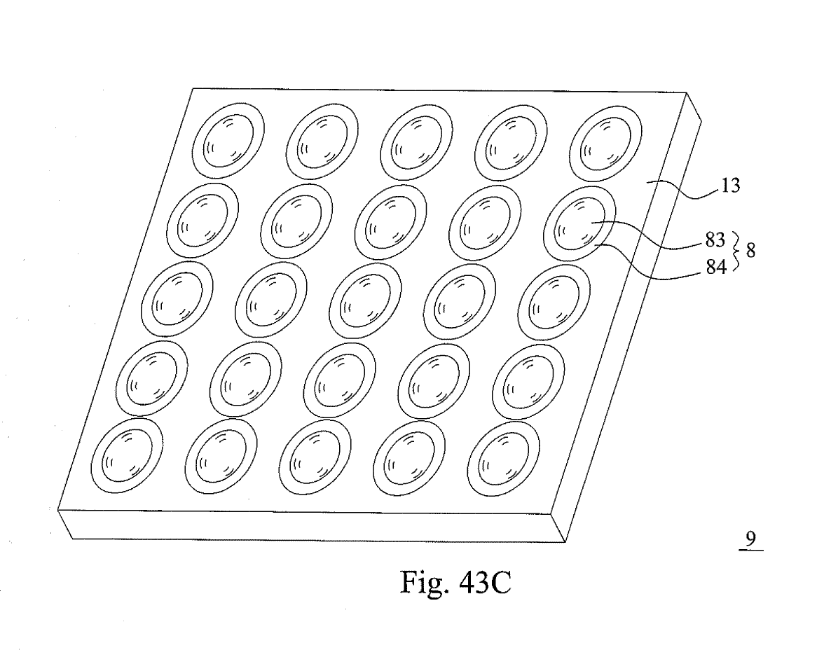

Furthermore, the present invention further includes several different embodiments. Please refer to FIG. 43A-43C. FIG. 43A illustrates a schematic diagram of the mold apparatus of the lens array before approaching the upper pressing die and the lower pressing die in accordance with another embodiment of the present invention. FIG. 43B illustrates a schematic diagram of the mold apparatus of the lens array after approaching the upper pressing die and the lower pressing die in accordance with another embodiment of the present invention. FIG. 43C illustrates a schematic diagram of the lens array finished in accordance with another embodiment of the present invention. As shown in the FIG. 43A-43C, the mold apparatus 1 of the lens array 9 of the present invention includes an upper pressing die 11, a lower pressing die 12 and a plate structure 13. The upper pressing die 11 includes a plurality of upper engaging portions 115. The lower pressing die 12 includes a plurality of lower engaging portions 125. Similar disclosure for the mutual relations of the plate structure 13 and the upper pressing die 11 and the lower pressing die 12 are not address again. In the present embodiment, the upper engaging portion 115 has a lateral width T1, and the lower engaging portion 125 has a lateral width T2. The lateral width T1 and the lateral width T2 could be a maximum horizontal intercept of the upper engaging portions 115 or the lower engaging portions 125 on the drawings. The plate structure 13 includes a plurality of through holes 135 disposed thereon. A glass article 8 can be installed at each of the through holes 135. The glass article 8 has a first sectional width W1. The first sectional width W1 is a maximum horizontal intercept of the glass article 8 depicted in the FIG. 43A. In the present embodiment, the glass article 8 is spherical ball.

As shown in the FIG. 43A and FIG. 43B, the glass article 8 is processed by the mold apparatus 1 of the lens array 9 of the present invention. After the upper pressing die 11 and the lower pressing die 12 are approached to the plate structure 13, the glass article 8, in a high temperature and softened state, can be extruded by the pressure exerted by the upper pressing die 11 and the lower pressing die 12, so as to form a body portion 83 and an extending portion 84. The body portion 83 is disposed in the through holes 135. As shown in the FIG. 43B, the extending portion 84 are disposed at two sides of the body portion 83; as shown in the FIG. 43C, the extending portion 84 which is around the body portion 83 is annular. In other words, the profile of the body portion 83 and the extending portion 84 is extruded and formed through the upper engaging portions 115 and the lower engaging portions 125. Therefore, the profile of the upper edge of the body portion 83 is the same to the profile of the upper engaging portions 115. The profile of the lower edge of the body portion 83 is the same to the profile of the low engaging portions 125. Moreover, after the glass article 8 is extruded, the body portion 83 of the glass article 8 can be firmly engaged in the through hole 135 of the plate structure 13 through the connection of the extending portion 84 (similar disclosure is referred to the step S07). As a result, it can ensure the glass articles 8 and the plate structure 13 are not loosened, swayed or departed. After the glass article 8 is engaged and integrated with the plate structure 13, the mold apparatus 1 can be opened and hence a lens array 9 (referring to the step S08.) depicted in the FIG. 43C can be consequently manufactured and formed.

Moreover, as shown in the FIG. 43A and FIG. 43B, the second sectional width W2 of the upper opening 131 is greater than the lateral width T1 of the upper engaging portion 115, i.e. W2>T1. The third sectional width W3 of the lower opening 132 is greater than the lateral width T2 of the lower engaging portion 125, i.e. W3>T2. As a result, it could ensure to form the extending portion 84. Noticed that, incident light ray passing through the lens array 9 mainly attributed to the body portion 83, namely the body portion 83 is effective incident area; contrarily that the extending portion 84 is ineffective incident area. In this manner, the extending portion 84 may compensate the manufacturing error or deviation of the lens array 9, even though the lens array 9 is disposed in the mold apparatus 1 and suffered extremely high squeezing pressure. In addition, the extending portion 84 in ineffective incident area, and therefore will not affect the incident light ray utilized. So the formation of the extending portion 84 will eventually play an important role during the whole manufacturing process. Furthermore, the lens array 9 depicted in the FIG. 20˜24 may be formed when the second sectional width W2 is equal to the lateral width T1, and the third sectional width W3 is equal to the lateral width T2. The lens array 9 depicted in the FIG. 16B and the FIG. 19 would be formed when the second sectional width W2 is less than the lateral width T1, and the third sectional width W3 is less than the lateral width T2. Therefore, the plate structure 13 is firmly fixed between the extending portion 85 and the extending portion 86, to have the glass article 8 connected to the plate structure 13 more stable.

As shown in the FIG. 43B, the plate structure 13 includes a thickness D1. In the preferred embodiment, a wingspan K1 (i.e., (W2−T1)/2) of the extending portion 84 is greater than the thickness D1 of the plate structure 13, or a wingspan K2 (i.e., (W3−T2)/2) of the extending portion 84 is greater than the thickness D1 of the plate structure 13. As a result, the extending portion 84 could release the molding pressure or compensate the error or deviation exerted from extruding stress, through extending the extending portion 84 in a horizontal direction.

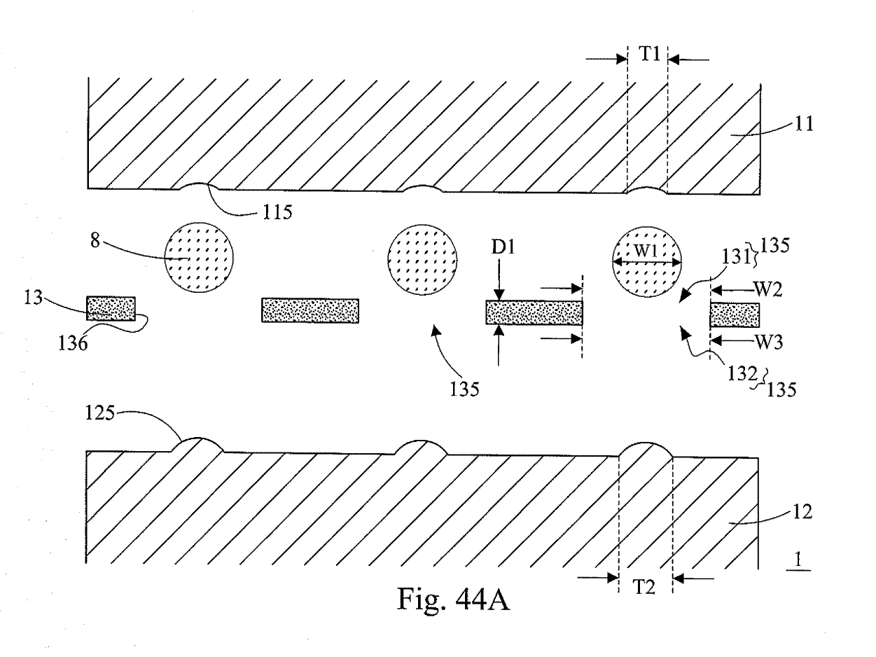

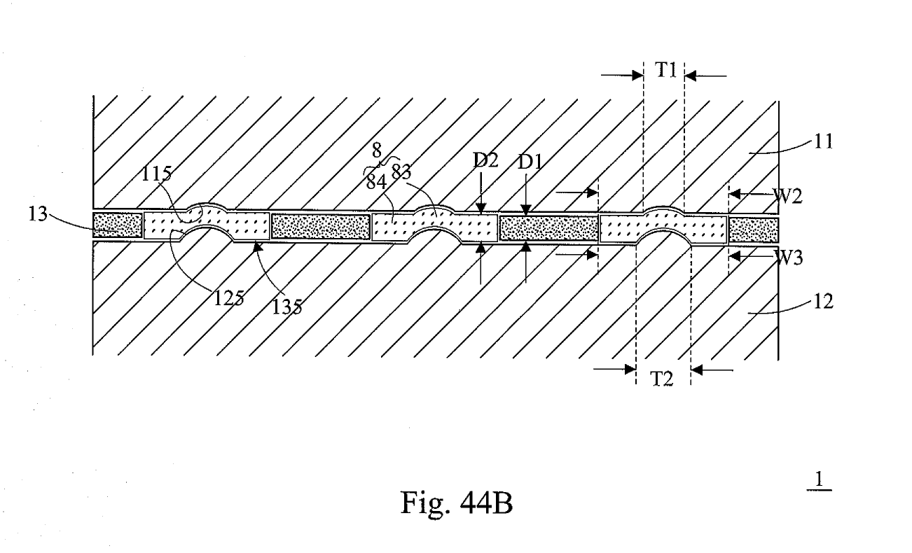

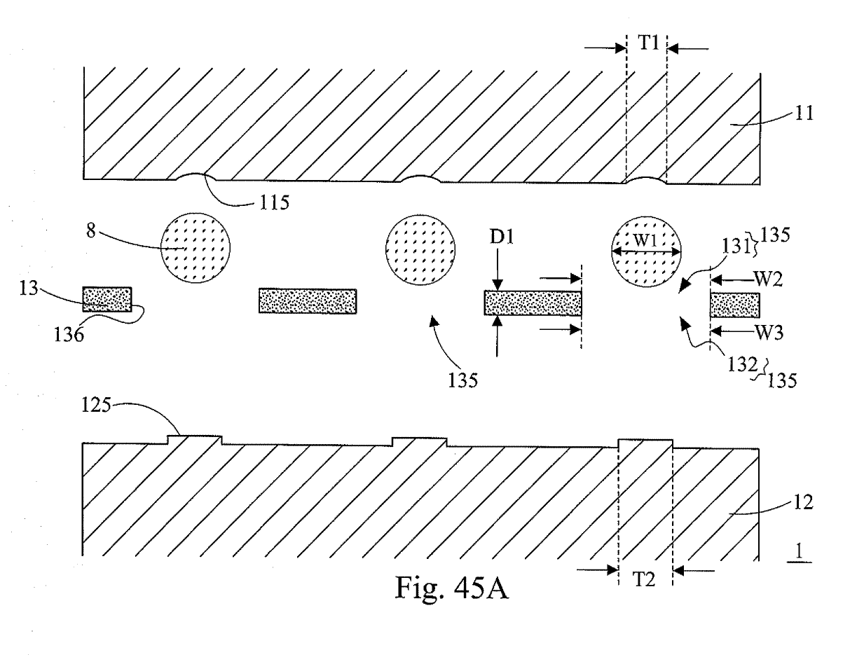

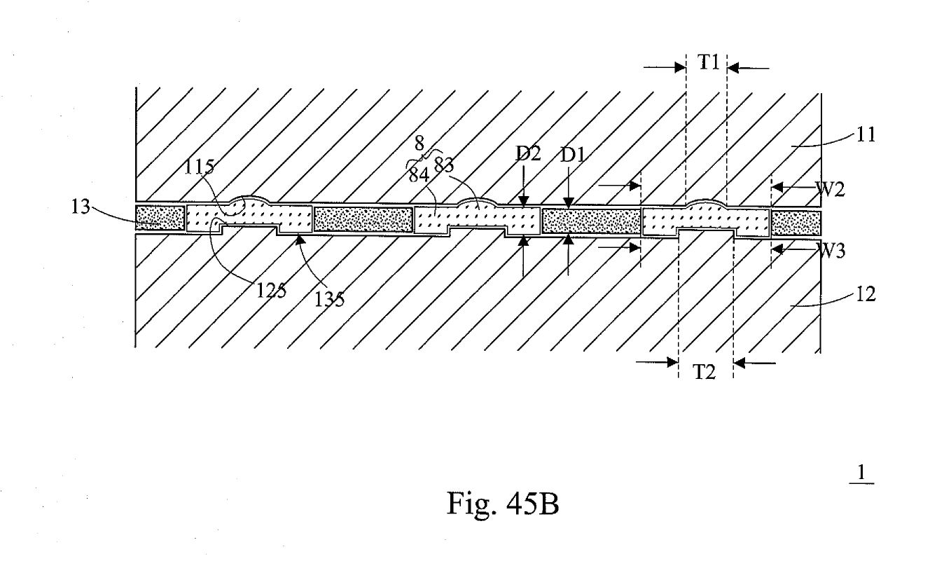

There are more embodiments of mold apparatus 1 of the lens array 9 disclosed. Please refer to FIG. 44A˜44B. The upper engaging portion 115 of the present embodiment presents as a concave. The lower engaging portion 125 presents as a protruding shape. Therefore, the upper edge of the body portion 83 presents as a protruding shape and the low edge of the body portion 83 presents as a concave if the upper pressing die 11 and the lower pressing die 12 are approached to the plate structure 13. Please refer to FIG. 45A˜45B. The upper engaging portion 115 presents as a concave and the lower engaging portion 125 presents as a protruding shape. Therefore, the upper edge of the body portion 83 presents as a circular protruding shape and the low edge of the body portion 83 presents as a rectangular concave if the upper pressing die 11 and the lower pressing die 12 are approached to the plate structure 13.

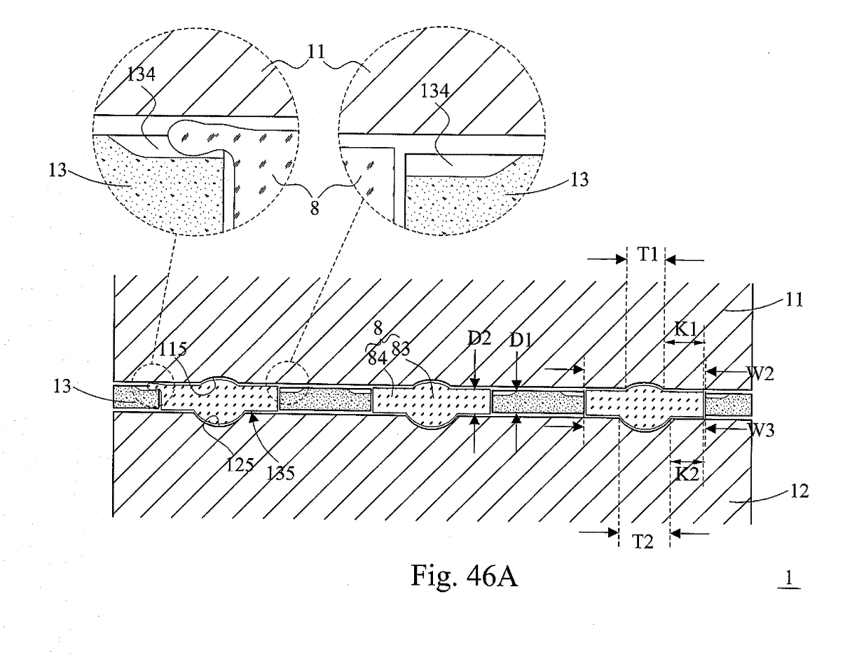

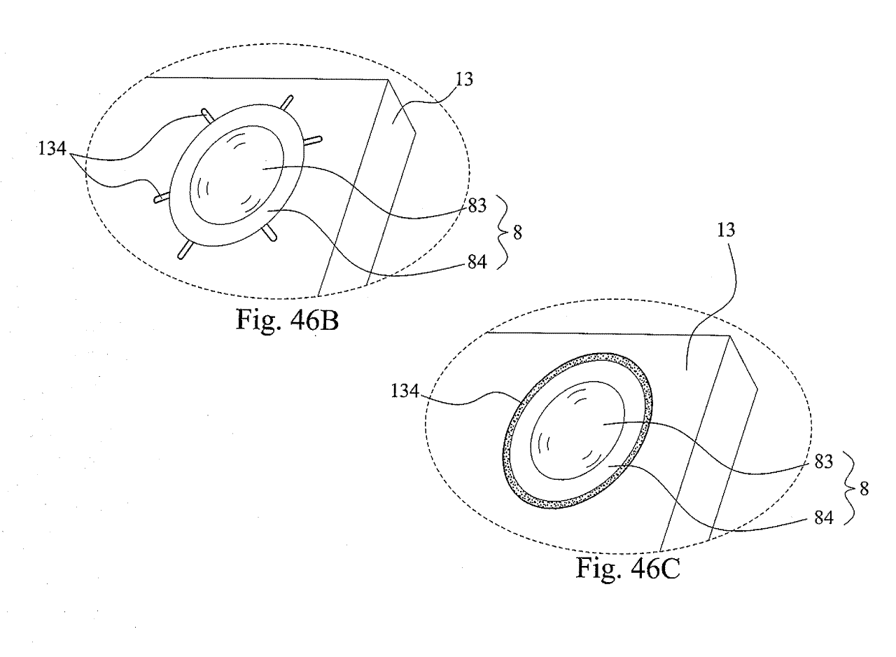

Please refer to FIG. 46A-46C. The FIG. 46A-46C illustrates a schematic diagram of a spillway of the mold apparatus of the lens array in accordance with another embodiment of the present invention. As shown in two enlarged views of the FIG. 46A, the mold apparatus 1 further includes at least one spillway 134 disposed adjacent to the through hole 135 of the plate structure 13. The spillway 134 is connected to the through hole 135. As a result, the glass article 8 with more volume of material could flow into the spillway 134 of the plate structure 13 when the glass article 8 is extruded. In this manner, the spillway 134 could receive the excess flow of the extruded material of the glass article 8, and ensure the location of the body portion 83 without unwanted deviation; therefore the precision is improved. As shown in the FIG. 46B, the spillway 134 disposed at the top side of the plate structure 13 could be a trench; besides the spillway 134 connected to the extending portion 84 of the glass article 8 can be many. As shown in the FIG. 46C, the spillway 134 disposed around and connected to the extending portion 84 of the glass article 8 might also present as a donut, and the spillway 134 is one in number. In this manner, the spillway 134 provides a reserve space for compensation, so as to receive excess flow of the extruded glass material, if the volume of the glass articles 8 has greater volume.

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A mold apparatus of a lens array, comprising:
an upper pressing die(11), including a plurality of upper engaging portions(115);
a lower pressing die(12), including a plurality of lower engaging portions(125);
a plate structure(13), movably disposed between the upper pressing die(11) and the lower pressing die(12), the plate structure(13) including a plurality of through holes(135) disposed thereon, with a glass article(8) installed at each of the through holes(135), the glass article(8) including a first sectional width W1, the through hole(135) including an upper opening(131) and a lower opening(132), the upper opening(131) corresponding to the upper pressing die(11), the lower opening(132) corresponding to the lower pressing die(12), the upper opening(131) including a second sectional width W2, the lower opening(132) including a third sectional width W3;
wherein the upper engaging portions(115) are disposed adjacent to the upper opening(131) and contacted to the glass article(8), and the lower engaging portions(125) are disposed adjacent to the lower opening(132) and contacted to the glass article(8) when the upper pressing die(11) and the lower pressing die(12) approaches to each other.

2. The mold apparatus of the lens array of claim 1, wherein W1≧W2 or W1≧W3.

3. The mold apparatus of the lens array of claim 1, wherein the upper engaging portion(115) includes a lateral width T1 and the lower engaging portion(125) includes a lateral width T2, and W2≧T1 or W3≧T2.

4. The mold apparatus of the lens array of claim 1, wherein the upper engaging portion(115) includes a lateral width T1 and the lower engaging portion(125) includes a lateral width T2, and W2≦T1 or W3≦T2.

5. The mold apparatus of the lens array of claim 1, wherein the shape of at least one upper engaging portion(115) is different from the shape of the lower engaging portion(125), or the area of at least one upper engaging portion(115) is different from the area of the lower engaging portion(125); wherein either the upper engaging portion(115) or the lower engaging portion(125) is a projecting structure, a concave structure, or a Fresnel lens structure.

6. The mold apparatus of the lens array of claim 1, wherein the shape of the upper opening(131) of the through hole(135) is different from the shape of the lower opening(132) of the through hole(135), or the area of the upper opening(131) of the through hole(135) is different from the area of the lower opening(132) of the through hole135); wherein the shape of the upper opening(131) or the lower opening(132) is circular, oval-shaped, polygon-shaped or irregular-shaped.

7. The mold apparatus of the lens array of claim 6, wherein the through hole(135) includes a bore wall(136) connected to the upper opening(131) and the lower opening(132); wherein the upper opening(131) is greater than, equal to or less than the lower opening(132), with a sectional view of the bore wall(136) presents as a straight line or a curve.

8. The mold apparatus of the lens array of claim 1, wherein the plate structure(13) includes at least one first through hole(135A) and at least one second through hole(135B), and the volume of the first through hole(135A) is different from the volume of the second through hole(135B) or the shape of the first through hole(135A) is different from the shape of the second through hole(135B), and the first through holes(135A) and the second through holes(135B) are arranged sequentially or arranged alternately or arranged regularly.

9. The mold apparatus of the lens array of claim 1, wherein each of the glass articles(8) includes, a different volume or a different shape; wherein the glass articles(8) includes at least one first configuration(8A) and at least one second configuration(8B); wherein the volume of the first configuration(8A) is different from the volume of the second configuration(8B) or the shape of the first configuration(8A) is different from the shape of the second configuration(8B), and the glass articles of the first configuration(8A) and the glass articles of the second configuration(8B) are arranged sequentially or arranged alternately or arranged regularly.

10. The mold apparatus of the lens array of claim 1, wherein the glass articles(8) include at least one first index of refraction and at least one second index of refraction, and the first index of refraction is different from the second index of refraction, and the glass articles(8) of the first index of refraction and the glass articles(8) of the second index of refraction are arranged sequentially or arranged alternately or arranged regularly; or the glass articles(8) include at least one first glass transition temperature and at least one second glass transition temperature, and the first glass transition temperature is different from the second glass transition temperature, and the glass articles(8) of the first glass transition temperature and the glass articles(8) of the second glass transition temperature are arranged sequentially or arranged alternately or arranged regularly.

11. The mold apparatus of the lens array of claim 1, wherein the plate structure(13) is non-transparent, or the plate structure(13) is curved.

12. The mold apparatus of the lens array of claim 1, wherein the volume of the glass article(8) is greater than or equal to the volume occupied of the through hole(135), or at least part of the volume of the glass article(8) is disposed in the through hole(135).

13. The mold apparatus of the lens array of claim 1, wherein the upper engaging portion(115) covers at least part of the upper opening(131) or the lower engaging portion(125) covers at least part of the lower opening(132) when the upper pressing die(11) and the lower pressing die(12) are approached to each other.

14. The mold apparatus of the lens array of claim 1, wherein the plate structure(13) includes at least one spillway(134) disposed adjacent to the through hole(135), with the spillway(134) connected to the through hole(135).

15. A method for using a mold apparatus of a lens array, the mold apparatus(1) of the lens array(9) including an upper pressing die(11), a lower pressing die(12) and a plate structure(13), the plate structure(13) including a plurality of through holes(135) disposed thereon, the method comprising:
step S01: providing the mold apparatus(1) of the lens array(9) and a plurality of glass article(8);
step S02: installing at least part of the volume of the glass articles(8) into the through holes(135);
step S03: approaching the upper pressing die(11) and the lower pressing die(12);
step S06: the upper pressing die(11) and the lower pressing die(12) extruding the glass articles(8) to have the glass articles(8) deformed;
step S07: the glass articles(8) closely engaged to, the through holes(135) of the plate structure(13);
step S08: taking out the plate structure(13) to form a lens array(9).

16. The method for using the mold apparatus of the lens array of claim 15, wherein the glass articles(8) of the step S02 are clamped into the through holes(135) by a robot arm; or the glass articles(8) of the step S02 roll to enter the through holes(135).

17. The method for using the mold apparatus of the lens array of claim 15, further comprising a step Tb implemented at least once, before the step S02 or after the step S02, wherein the step Tb heats up a plurality of glass articles(8).

18. The method for using the mold apparatus of the lens array of claim 15, further comprising a step Ta, wherein the step Ta makes the surface of the plate structure(13) or the interior of the plate structure(13) be non-transparent.

19. The method for using the mold apparatus of the lens array of claim 18, wherein the plate structure(13) is non-transparent through a surface coating method, a surface blasting method, an atomizing surface method, or an internal doping method.

20. The method for using the mold apparatus of the lens array of claim 15, wherein the glass article(8) includes a first sectional width W1, and the upper opening(131) of the through hole(135) includes a second sectional width W2, and the lower opening(132) of the through hole(135) includes a third sectional width W3; wherein W1≧W2 or W1≧W3.

21. The method for using the mold apparatus of the lens array of claim 15, wherein the step S03 further comprises a sub-step S04 or a sub-step S05; wherein the sub-step S04: the upper pressing die(11) approaching the plate structure(13) and contacting to the glass articles(8); wherein the sub-step S05: the lower pressing die(12) approaching the plate structure(13) arid contacting to the glass articles(8).

22. The method for using the mold apparatus of the lens array of claim 15, wherein the glass articles(8) are extruded to form a upper end portion(81) and a lower end portion(82) after the step S06, wherein the upper end portion(81) and the lower end portion(82) are disposed at two ends of the through hole(135); wherein a lateral width(H1) of the upper end portion(81) is greater than or equal to a sectional width(W2, W3) of the through hole(135), or a lateral width(H2) of the lower end portion(82) is greater than or equal to the sectional width(W2, W3) of the through hole(135).

23. The method for using the mold apparatus of the lens array of claim 15, wherein the step S02, the step S03, the step S06, and the step S07 sequentially implemented is defined as an inner loop, and the inner loop is repeated for a plurality of times; wherein the glass transforming temperature of the glass articles(8) of the through hole(135) of the later inner loop is lower than the glass transforming temperature of the glass articles(8) of the through hole(135) of the earlier inner loop.
